(19) United States
(12) Patent Application Publication
(10) Pub. No.: US 2026/0178940 A1
(43) Pub. Date: Jun. 25, 2026

(54) METHOD OF INFERRING USER'S INTEREST AND USER DEVICE USING THE SAME

(71) Applicant: SAMSUNG ELECTRONICS CO., LTD., Suwon-si (KR)

(72) Inventors: Hyewoen KIM, Suwon-si (KR); Myunghee Han, Suwon-si (KR); Hongjun Jang, Suwon-si (KR); Chaeseung Lim, Suwon-si (KR); Heejung Yeom, Suwon-si (KR); Junmo Park, Suwon-si (KR); Sunggwan Park, Suwon-si (KR); Sangsoo Park, Suwon-si (KR); Sangchul Ku, Suwon-si (KR)

(73) Assignee: SAMSUNG ELECTRONICS CO., LTD., Suwon-si (KR)

(21) Appl. No.: 19/432,370

(22) Filed: Dec. 24, 2025

Related U.S. Application Data
(63) Continuation of application No. PCT/KR2025/022346, filed on Dec. 19, 2025.

(30) Foreign Application Priority Data
Dec. 24, 2024 (KR) 10-2024-0196200

(51) Int. Cl. G06N 5/04; G06N 5/022

(52) U.S. Cl. CPC G06N 5/04; G06N 5/022

(57) ABSTRACT

Provided is a method of inferring an interest associated with a user, the method including obtaining time span information for determining interest associated with the user from a query; obtaining user interaction-based semantic index information from at least one system log knowledge graph, the at least one system log knowledge graph corresponding to the time span information; searching for at least one contact node, based on user interaction-based semantic index information, in at least one user log knowledge graph, the at least one user log knowledge graph corresponding to the time span information, each of user log knowledge graph including, as respective nodes, entities related to activity information associated with the user; and obtaining the interest associated with the user corresponding to the time span information, based on at least one node that satisfies a preset condition, from a user log knowledge graph including the at least one contact node.

### CROSS-REFERENCES TO RELATED APPLICATIONS

This application is a continuation of International Application No. PCT/KR2025/022346, filed on Dec. 19, 2025, which claims priority to Korean Patent Application No. 10-2024-0196200, filed on Dec. 24, 2024, in the Korean Intellectual Property Office, the disclosures of which are incorporated by reference herein in their entireties.

### BACKGROUND

### 1. Field

The disclosure relates to a method of inferring a user's interest and a user device using the same.

### 2. Description of Related Art

Artificial intelligence (AI)-based technologies have been utilized in various fields across industries. Various AI models have been developed and used in various fields. Fields in which AI-based solutions are applied to various industries including manufacturing, robotics, transportation/logistics, medical treatment, education, pharmaceutical/bio industries, etc. are rapidly increasing. The introduction of such AI-based technologies has led to enhanced competitiveness for companies and countries.

In order to improve the performance of AI models, a knowledge base for training an AI model learning and inference by the AI model may be used. An example of a knowledge base is a knowledge graph that has a graph-type data structure.

Recently, there has been an increasing interest in on-device AI technologies whereby a user device such as a smartphone autonomously collects and processes information, rather than technologies whereby information collected by a user device such as a smartphone is transmitted, analyzed, and transmitted back to the user device by a server. This interest stems from privacy concerns and reducing processing costs associated with large scale AI models.

### SUMMARY

According to an embodiment of the disclosure, a method of inferring an interest associated with a user, the method being performed by at least one processor, the method obtaining time span information for determining the interest associated with the user from a query; obtaining user interaction-based semantic index information from at least one system log knowledge graph, the at least one system log knowledge graph corresponding to the time span information, wherein each system log knowledge graph comprises, as respective nodes, results of aggregating system log data according to system monitoring criteria; searching for at least one contact node, based on the user interaction-based semantic index information, in at least one user log knowledge graph, the at least one user log knowledge graph corresponding to the time span information, wherein each of the at least one user log knowledge graph comprises entities related to activity information associated with the user based on user log data and comprises representations of relationships between the entities; and obtaining the interest associated with the user corresponding to the time span information, based on at least one node that satisfies a preset condition, from a user log knowledge graph comprising the at least one contact node.

According to an embodiment of the disclosure, a non-transitory computer-readable recording medium storing instructions is provided. The instructions when executed by at least one processor of an electronic device, collectively or individually, cause the electronic device to obtain time span information for determining the interest associated with a user from a query; obtain user interaction-based semantic index information from at least one system log knowledge graph, the at least one system log knowledge graph corresponding to the time span information, wherein each system log knowledge graph comprises, as respective nodes, results of aggregating system log data according to system monitoring criteria; search for at least one contact node, based on the user interaction-based semantic index information, in at least one user log knowledge graph, the at least one user log knowledge graph corresponding to the time span information, wherein each of the at least one user log knowledge graph comprises, as respective nodes, entities related to activity information associated with the user nodes based on user log data and comprises representations of relationships between the entities; and obtain an interest associated with the user corresponding to the time span information, based on at least one node that satisfies a preset condition, from a user log knowledge graph comprising the at least one contact node.

According to an embodiment of the disclosure, a user device that infers an interest associated with a user is provided. The user device includes memory including one or more storage mediums storing instructions, and at least one processor including processing circuitry. One or more instructions, when executed by the at least one processor individually or collectively, cause the user device to obtain time span information for determining the interest associated with a user from a query; obtain user interaction-based semantic index information from at least one system log knowledge graph, the at least one system log knowledge graph corresponding to the time span information, wherein each system log knowledge graph comprises, as respective nodes, results of aggregating system log data according to system monitoring criteria; search for at least one contact node, based on the user interaction-based semantic index information, in at least one user log knowledge graph, the at least one user log knowledge graph corresponding to the time span information, wherein each of the at least one user log knowledge graph comprises, as respective nodes, entities related to activity information associated with the user based on user log data and comprises representations of relationships between the entities; and obtain an interest associated with the user corresponding to the time span information, based on at least one node that satisfies a preset condition, from a user log knowledge graph comprising the at least one contact node.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a personal knowledge graph-based artificial intelligence (AI) platform according to an embodiment of the disclosure;

FIG. 2 is a diagram illustrating an operation performed by a user device to construct a knowledge graph-based personalized database, according to an embodiment of the disclosure;

FIG. 3 is a diagram illustrating a process performed by a user device to generate a user log knowledge graph, according to an embodiment of the disclosure;

FIG. 4 is a diagram illustrating a user log knowledge graph according to an embodiment of the disclosure;

FIG. 5 is a diagram illustrating a user log knowledge graph according to an embodiment of the disclosure;

FIG. 6 is a diagram illustrating a process performed by a user device to generate a system log knowledge graph, according to an embodiment of the disclosure;

FIG. 7 is a diagram illustrating a system log knowledge graph according to an embodiment of the disclosure;

FIG. 8 is a diagram illustrating integration of system log knowledge graphs, according to an embodiment of the disclosure;

FIG. 9 is a diagram illustrating an operation performed by a user device to provide a personal knowledge graph-based service, according to an embodiment of the disclosure;

FIG. 10 is a flowchart illustrating a method of inferring a user's interest, the method being performed by a user device, according to an embodiment of the disclosure;

FIG. 11 is a diagram illustrating a connection relationship between a system log knowledge graph and a user log knowledge graph, according to an embodiment of the disclosure;

FIG. 12 is a diagram illustrating an interest knowledge graph obtained by merging a system log knowledge graph with a user log knowledge graph, according to an embodiment of the disclosure;

FIG. 13 is a diagram illustrating a process of inferring a user's interest by using a system log knowledge graph and a user log knowledge graph, according to an embodiment of the disclosure;

FIG. 14 is a diagram illustrating a method of obtaining a user's interest when keywords corresponding to a plurality of entities are obtained, the method being performed by a user device, according to an embodiment of the disclosure;

FIG. 15 is a diagram illustrating a process of inferring a user's interest by using a system log knowledge graph and a user log knowledge graph, according to an embodiment of the disclosure;

FIG. 16 is a diagram illustrating graph generated using a method of providing a user's interest corresponding to a preset time span to the user, the method being performed by a user device, according to an embodiment of the disclosure;

FIG. 17 is a block diagram illustrating an operation of a processor of a user device, according to an embodiment of the disclosure; and

FIG. 18 is a block diagram illustrating a configuration and operations of a user device, according to an embodiment of the disclosure.

### SUMMARY

The terms used in the specification will be briefly defined, and the disclosure will be described in detail. Throughout the disclosure, the expression “at least one of a, b or c” indicates only a, only b, only c, both a and b, both a and c, both b and c, or all of a, b, and c.

Although the terms used in the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

As used herein, the singular forms “a,” “an,” and “the” may include the plural forms as well, unless the context clearly indicates otherwise. Unless otherwise defined, all terms including technical or scientific terms used herein may have the same meanings as commonly understood by one of ordinary skill in the art of the disclosure. It will be understood that, although the terms “first”, “second”, etc. may be used in the specification so as to describe various components, these components should not be limited by these terms. These terms are only used to distinguish one component from another component.

Throughout the specification, when a part “includes” or “comprises” a component, unless there is a particular description contrary thereto, the part can further include other components, not excluding the other components. Also, the terms such as “unit,” “module,” or the like used in the specification indicate a unit, which processes at least one function or operation, and the unit may be implemented by hardware or software, or by a combination of hardware and software.

The functions related to artificial intelligence (AI) according to the disclosure are operated via a processor and memory. The processor may refer to one or more processors. In this regard, the one or more processors may include at least one of a general-purpose processor such as a central processing unit (CPU), an application processor (AP), a digital signal processor (DSP), or the like, a graphics-dedicated processor such as a graphics processing unit (GPU), a vision processing unit (VPU) or the like, or an AI-dedicated processor such as a neural processing unit (NPU). The one or more processors control input data to be processed according to a predefined operation rule or an AI model which is stored in the memory. Alternatively, when each of the one or more processors is an AI-dedicated processor, the AI-dedicated processor may be designed to have a hardware structure specialized for processing of a particular AI model.

The predefined operation rule or the AI model is made via training. Herein, when the predefined operation rule or the AI model is made via training, it may mean that a basic AI model is trained by using multiple training data based on a learning algorithm so as to execute desired characteristics (or purpose), thus making the predefined operation rule or AI model. Such training may be performed by a device on which AI according to the disclosure is implemented or by a separate server and/or a system. Examples of the learning algorithm may include, but are not limited to, supervised learning, unsupervised learning, semi-supervised learning, or reinforcement learning.

The AI model may include a plurality of neural network layers. Each of the plurality of neural network layers has a plurality of weight values, and performs a neural network calculation via a calculation between a calculation result of a previous layer and the plurality of weight values. The plurality of weight values of the plurality of neural network layers may be optimized due to a training result of the AI model. For example, the plurality of weight values may be updated to reduce or minimize a loss value or a cost value obtained by the AI model during a training process. Examples of the AI neural network may include, but are not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a DQN.

In the disclosure, a “knowledge graph” is a scheme of managing and searching for knowledge information and refers to a graph-structured knowledge base based on a knowledge base that stores knowledge information and a graph that expresses knowledge information so as to be analyzed in a network structure. The knowledge graph is a graph model that implements knowledge accumulated in the knowledge base as a relationship between nodes and edges. The knowledge graph may be used to integrate data by using graph data models, topologies, etc. In order to enable knowledge to be interconnected and integrated by using a knowledge graph, a schema is implemented via ontology, and a structure and dictionary (terminology) that may be shared with each other are used.

Semantic information including commonsense and fact knowledge is organized as connections between nodes and edges, and various types of data may be converted into the form of a knowledge graph with reference to the semantic information. As a scheme of expressing a knowledge graph, a labeled property graph (LPG) in which a node and an edge each have properties, a resource description framework (RDF) that expresses a relationship in a triple-fact structure of subject-predicate-object, etc. may be used, but the disclosure is not limited thereto. The knowledge graph may be generated by recognizing entities from various data, performing linking (entity linking) to appropriate entities in an existing knowledge base, and extracting a relationship between the entities.

The knowledge graph may be utilized to improve the performance of AI. The knowledge graph may be used in models, such as a graph neural network (GNN) or a graph convolution neural network (GCN), and may be used to provide a description of a result in an explainable AI (XAI).

Hereinafter, an embodiment of the disclosure will be described in detail with reference to the accompanying drawings, so that one of ordinary skill in the art may easily carry out the disclosure. However, the disclosure may be implemented in various different forms and is not limited to the embodiment of the disclosure described herein.

Hereinafter, the disclosure will now be described in detail with reference to the accompanying drawings.

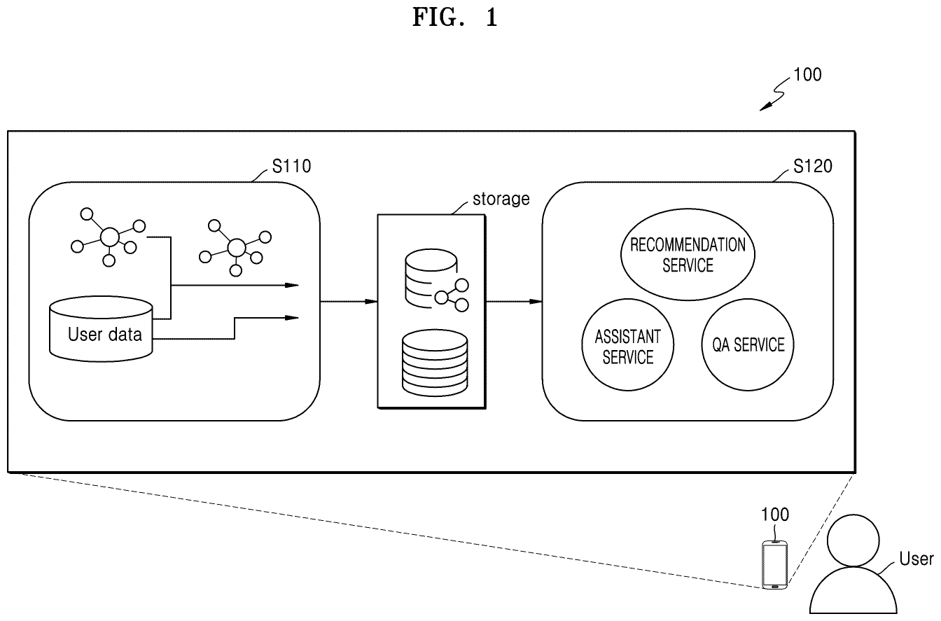

FIG. 1 is a diagram for describing a personal knowledge graph-based AI platform according to an embodiment of the disclosure.

Referring to FIG. 1, a personal knowledge graph-based AI platform is provided to a user by a process of constructing a knowledge graph-based personalized database (S110) and a process of providing a personalized AI service to a user via a knowledge graph-based service application (S120).

In the process of constructing the knowledge graph-based personalized database (S110), a user device 100 may generate a personal knowledge graph of a standardized form with reference to a general knowledge graph of a standardized form, such as commonsense and fact knowledge, by using user data obtained by the user device 100. The user device 100 may convert various types of unstructured data into the form of a knowledge graph, may construct a knowledge graph-based personalized database, i.e., a personal knowledge graph, and may store the personal knowledge graph in a storage. The user device 100 may database user data obtained by the user device 100 and may manage the user data in a storage.

In the process of providing the personalized AI service to the user via the knowledge graph-based service application (S120), the user device 100 may provide various services by using the personal knowledge graph and the databased user data stored in the storage. The user device 100 may provide a recommendation service, an assistant service, a question answering (QA) service, etc. by using the personal knowledge graph.

For example, when an action is performed by the user, the user device 100 may recommend, via the recommendation service, music that the user enjoys listening to while performing the action, or may provide, via the assistant service, not only information about related past experiences or upcoming events (for example, calendar schedules) but also personal knowledge graph-based knowledge information. The user device 100 may identify the user's behavioral pattern from the personalized database and, when the user exhibits a pattern that is different from a usual behavioral pattern, the user device 100 may provide, via the recommendation service, a solution service related to the cause of the different pattern. The user device 100 may provide, via the QA service, personalized answers to the user's questions, based on the personalized database. The user device 100 may provide a journal service to manage and describe the user's daily routine and special event, etc. by utilizing the personalized database.

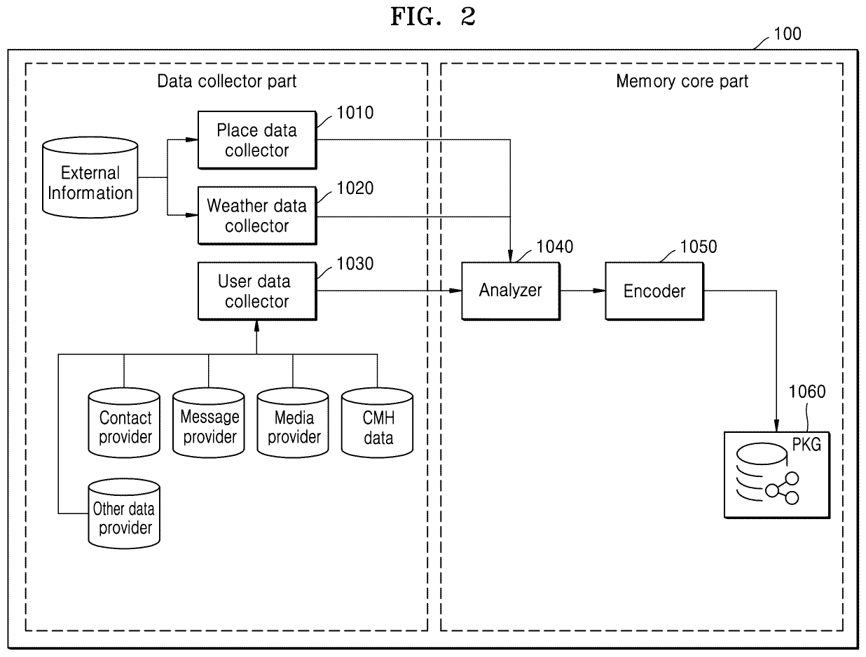

FIG. 2 is a diagram for describing an operation performed by the user device 100 to construct a knowledge graph-based personalized database, according to an embodiment of the disclosure.

The user device 100 according to an embodiment of the disclosure may be an electronic device capable of processing data. For example, the user device 100 may be an electronic device such as a smartphone, smart glasses, a wearable device, a digital camera, a laptop computer, an augmented reality (AR) device, or a virtual reality (VR) device. Various types of neural network models may be mounted on the user device 100. For example, the user device 100 may have at least one of models such as a CNN, a GCN, a GNN, a DNN, an RNN, or a BRDNN, mounted thereon, and may use a combination thereof.

The user device 100 according to an embodiment of the disclosure may convert various types of unstructured data into the form of a knowledge graph and construct a knowledge graph-based personalized database. The user device 100 may obtain various types of data and convert the data into triple-format data. The user device 100 may map the converted data to ontology stored in a semantic memory and may reflect the standardized data matching the ontology format in the personal knowledge graph. The ontology is a type of dictionary that defines terms conceptualizing data and a relationship between the terms. The ontology may be expanded by converting external knowledge into triple-format data and adding the triple-format data.

The data obtained by the user device 100 according to an embodiment of the disclosure may be those stored in the user device 100 as user data related to an application executed in the user device 100 or as metadata about event occurrence time, place, weather, etc. The data obtained by the user device 100 may include at least one of data input from the user via the user device 100, data detected by the user device 100, data received from the external source by the user device 100, or data processed by the user device 100.

The user device 100 may process unstructured data obtained by the user device 100 into structured data and may store the structured data in the personal knowledge graph. The user device 100 may previously prepare semantic information of a standardized form, as ontology. By referring to semantic information of various types of ontologies, the user device 100 may process unstructured data obtained by the user device 100 into structured data and may store the structured data in the personalized database. For example, the user device 100 may convert various types of unstructured data into the form of a knowledge graph and store the knowledge graph in the personal knowledge graph.

FIG. 2 illustrates an example of a process performed by the user device 100 to collect the user data related to the application executed in the user device 100 and construct a personalized database in the form of a knowledge graph.

In a data collector part of the user device 100, a user data collector 1030 may collect user data from a contact provider, a message provider, a media provider, content management hub (CMH) data, other data provider, etc. Each provider may store data at the level of raw data provided from at least one application. For example, the message provider may store user data in the form of raw data received from a text message application or a chat application. The user data collector 1030 is not limited to the example shown in FIG. 2, and may collect user data from various types of applications including a third-party application installed in the user data collector 1030. A place data collector 1010 and a weather data collector 1020 may collect metadata about a place or weather from external information obtained by the user device 100. Referring to FIG. 2, the place data collector 1010, the weather data collector 1020, and the user data collector 1030 are separate, but they are not limited thereto and may be integrated into one collector.

Each of the data collectors 1010, 1020, and 1030 collects log data or data at the level of raw data. For example, the user data collector 1030 may collect a picture file itself from a picture management application for managing pictures photographed by a camera. The user data collector 1030 may receive user data transmitted from each application according to a predefined protocol for each domain or each provider. When an event such as addition, change, deletion, etc. of user data stored in each application occurs, the user data collector 1030 may receive added user data, changed user data, or deleted user data from each application.

In a memory core part of the user device 100, an analyzer 1040 may generate user data in a new form by using all or a part of data collected by each of the data collectors 1010, 1020, and 1030.

The analyzer 1040 may generate user data at the level of action information or activity information, from the data collected by each of the data collectors 1010, 1020, and 1030. The analyzer 1040 may infer and determine a user action of capturing a picture from the picture, a user action of eating food from a paid receipt of a restaurant, a user action of staying from global positioning system (GPS)-based position information of a place where a user is present, etc., and thus, may generate the user data at the level of action information or activity information. The action information may be user data corresponding to an operation (unit action) of the user, and the activity information may be user data configured with a plurality of pieces of sequential action information. The activity information may have attribute data in which a value of a start time and a value of an end time are different from each other, whereas the action information may have attribute data about a value of a time at which the operation of the user occurred. For example, with respect to watching movie, a time when the watching move started and a time when the watching movie ended are different, and thus, the watching movie may correspond to the activity information, but with respect to payment, a time when payment occurred is momentary, the payment may correspond to the action information. However, the action information may be processed as one type of activity information in which a start time and an end time are equal.

The analyzer 1040 may generate user data at the level of a personal knowledge graph. The analyzer 1040 may obtain the action information or the activity information, based on the data collected by each of the data collectors 1010, 1020, and 1030, may connect entities as respective nodes related to the action information or the activity information, and may store attribute information of each node, thereby generating the personal knowledge graph. For example, the personal knowledge graph may be configured with a lower layer including user data at the level of raw data, a middle layer including user data at the level of action information or activity information, and an upper layer corresponding to the level of a title or topic of the personal knowledge graph and collectively including the action information or the activity information, but the personal knowledge graph is not limited to the form of such a hierarchical structure. A plurality of nodes corresponding to the activity information included in the middle layer may be connected to the uppermost layer of the personal knowledge graph. A plurality of nodes corresponding to the user data at the level of raw data included in the lower layer may be connected as attribute data of each activity information to each node corresponding to the activity information. The nodes corresponding to the activity information of the personal knowledge graph may be connected to each other, and a node corresponding to another user data may be connected to a node corresponding to the user data. Nodes corresponding to similar user data included in one or more personal knowledge graphs may be clustered and managed as one group. For example, pictures including similar faces of a user may be managed as one group, and when attribute information about any one of the pictures is input, all the pictures in the same group may share the input attribute information. It may be processed in such a manner that, when any one picture in the same group is deleted, all pictures in the same group are deleted from one or more personal knowledge graphs. As another example, a personal knowledge graph may represent user data generated during a preset time span by designating preset time span information as a root node, with each node connected to the root node. The root node may be searched for via the preset time span information. The root node may be connected to each personal knowledge graph in which each sub-time span information, constituting preset time span information, is a sub-root node.

An encoder 1050 may convert user data into triple-format data, the user data being generated or processed by the analyzer 1040, may map the converted user data to preset ontology, may infer standardized data matching the ontology format, and may construct a personal knowledge graph in a storage 1060 or may reflect the inferred data in an existing personal knowledge graph. Various types of ontologies such as content ontology, activity information ontology, environment ontology, and relationship ontology may be previously prepared in the user device 100. The encoder 1050 may integrate and use the various ontologies prepared in the user device 100. For example, the encoder 1050 may convert information of card payment occurred on January 1 and user data related to a picture photographed on January 1 to triple-format data, may identify the converted user data as each of activity information of the payment and activity information of taking pictures occurred on January 1 by using the activity information ontology, and may generate or update a personal knowledge graph based on the activity information in a standardized form.

The storage 1060 may store a personal knowledge graph. The user device 100 may manage personal knowledge graphs by constructing a knowledge graph-based personalized database in the storage 1060. The user device 100 may record and store data related to an event occurred by a user for each preset time span, the data in a personal knowledge graph form. In order to record and manage events occurred in the user device 100, by using various types of user data, the user device 100 may store and manage a personal knowledge graph including each node as an entity related to an event.

Hereinafter, a method, performed by the user device 100, of generating various types of personal knowledge graphs, and a method, performed by the user device 100, of inferring a user's interest by using various types of personal knowledge graphs to provide personalized services, will be described in detail.

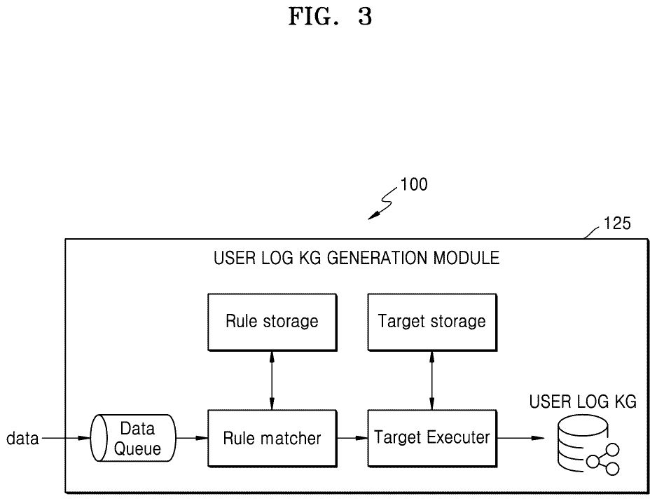

FIG. 3 is a diagram for describing a process performed by the user device 100 to generate a user log knowledge graph, according to an embodiment of the disclosure.

Referring to FIG. 3, the user device 100 may include a user log knowledge graph generation module 125. The user log knowledge graph generation module 125 may include a data queue, a rule storage, a rule matcher, a target storage, and a target executer, but the names and detailed configurations thereof are not limited thereto.

The data queue may receive (subscribe to) data published by various data-generating entities. The data-generating entities may be an application, a framework, a system, a developer, a user, etc. The rule storage may store a specification about a condition of data under which a target action is performed. For example, the rule storage may store filter conditions, such as condition information about strings, system time information, or third-party information related to data. The rule matcher may determine whether data matches a condition with reference to the rule storage. The target storage may store a specification about how data is transformed and which target action is to be performed. The target executer may determine a target action to be performed with reference to the target storage, and may perform the target action. The target executer may establish connection pooling for frequently accessed large language models or knowledge graphs. The target executer may refer to a cache for identical requests, which enables fast return. The target executer may store a triple fact in an existing knowledge graph in which connections are set up.

The user log knowledge graph generation module 125 may generate a user log knowledge graph in which entities related to a user's activity information based on user log data are set as respective nodes and in which a relationship between the entities is represented. The user log knowledge graph is a personal knowledge graph that stores a triple fact extracted from user log data generated as a user interacts with the user device 100. The user log data refers to records of data about an event occurred by a user, and may include information about a process of an application executed by the user, an operational state or execution result of the process, and user data at the level of raw data related to the application executed by the user. The user log knowledge graph generation module 125 may perform an operation such as generating, updating, deleting, or retrieving a user log knowledge graph. The user log knowledge graph generation module 125 may manage triple facts extracted from old user log data, and in some cases, may refine a user log knowledge graph so that only keyword-centric facts remain.

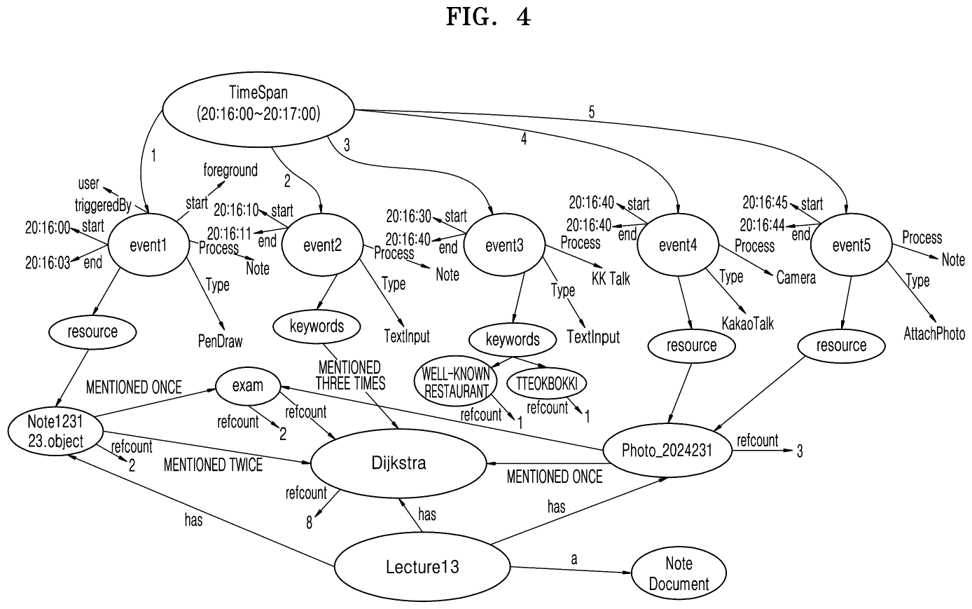

FIG. 4 is a diagram for describing a user log knowledge graph according to an embodiment of the disclosure.

Referring to FIG. 4, the user device 100 may generate a knowledge graph in which time span information of “20:16 to 20:17” is set as a root node, five events that occurred in the user device 100 during the one minute of the time span information are set as respective nodes connected to the root node, and attribute data for each event is recorded. Each event may be represented as extractable facts, such as whether it is foreground work perceivable by a user, whether it is triggered by the user, which application's process is being executed, the type of input interface, and a start time and an end time.

Referring to the example shown in FIG. 4, a first event (event 1) relates to the user executing a note application as foreground work to generate an output via a pen input, and it may be seen that the first event was performed from 20:16:00 to 20:16:03. It may be seen that the first event generated an output via a pen input, named “Note123123.object,” mentioning the keywords “exam” and “Dijkstra”. A second event (event 2) relates to generating an output via a text input in the note application, and it may be seen that the second event was performed from 20:16:10 to 20:16:11. It may be seen that the second event generated an output via a text input mentioning the keyword “Dijkstra” referenced eight times by other nodes. A third event (event 3) relates to generating an output via a text input in an application named “KK Talk,” and it may be seen that the third event was performed from 20:16:30 to 20:16:40. It may be seen that the third event generated an output via a text input mentioning the keywords “well-known restaurant” and “tteokbokki,” each referenced once by other nodes. A fourth event (event 4) corresponds to generating an output named “photo_2024231” obtained via capture of a picture by using a camera application, and it may be seen that the fourth event was performed instantaneously from 20:16:40 to 20:16:40. It may be seen that the fourth event generated a picture named “photo_2024231” mentioning the keywords “exam” and “Dijkstra” and included in “Lecture13.” A fifth event (event 5) relates to attaching the picture named “photo_2024231,” which is the output obtained via the capture of the picture in the fourth event, in the note application, and it may be seen that the fifth event was performed instantaneously from 20:16:45 to 20:16:45.

The user device 100 according to an embodiment of the disclosure may record, for each preset time span, data related to an event occurred in the user device 100, and may store the data in a knowledge graph form. The user device 100 may generate a user log knowledge graph in which keywords extracted from each output are set as respective nodes and in which a relationship between the keywords is represented, as shown in FIG. 4, with respect to the outputs generated via each event occurred in the user device 100.

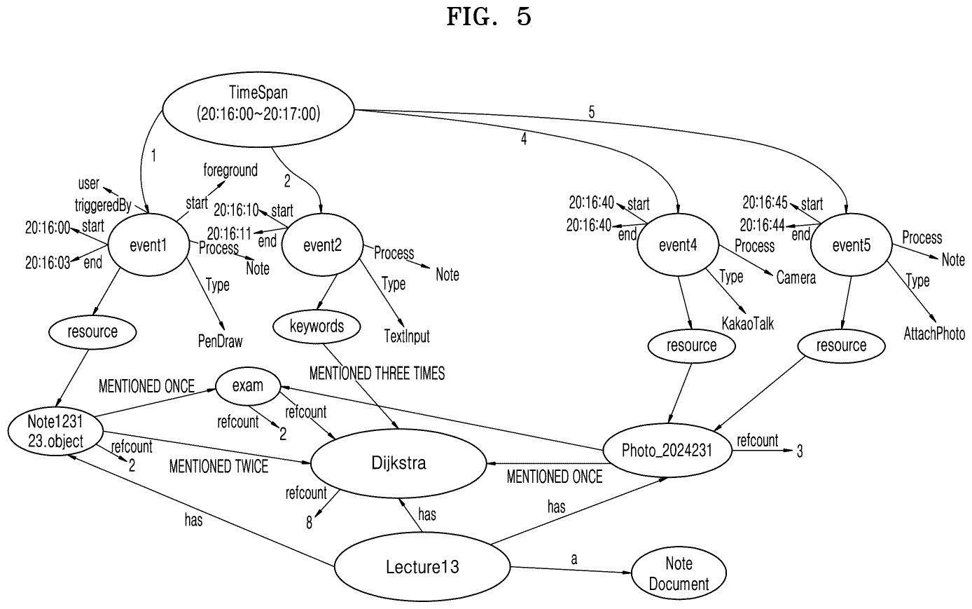

FIG. 5 is a diagram for describing a user log knowledge graph according to an embodiment of the disclosure.

The user device 100 according to an embodiment of the disclosure does not store data related to all events occurred in the user device 100, but may delete and store data related to some events that have no relevance to other events. In the user log knowledge graph described in FIG. 4, it may be seen that, the output generated via the third event, among the events occurred within a preset time span, has no relevance to the outputs generated via other events and corresponds to keywords that are not semantically influential, considering the number of times they are referenced by other nodes. Referring to FIG. 5, the user device 100 according to an embodiment of the disclosure may delete, from the user log knowledge graph, nodes corresponding to the output generated via the third event and store the user log knowledge graph.

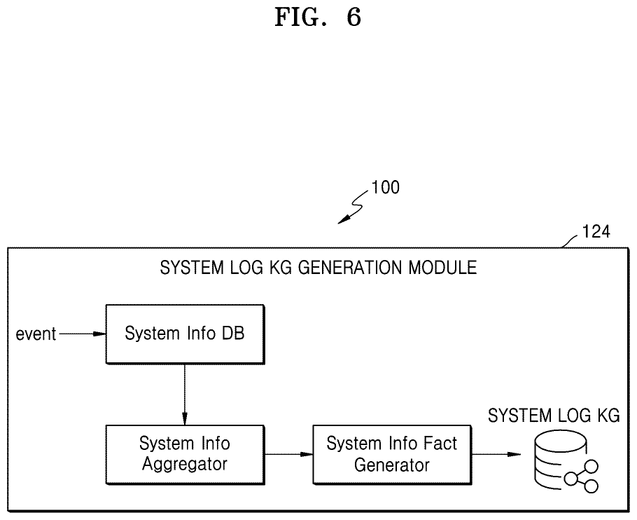

FIG. 6 is a diagram for describing a process performed by a user device to generate a system log knowledge graph, according to an embodiment of the disclosure.

Referring to FIG. 6, the user device 100 may include a system log knowledge graph generation module 124. The system log knowledge graph generation module 124 may include a system information database (system info DB), a system information aggregator (system info aggregator), and a system information fact generator (system info fact generator), but the names and detailed configurations thereof are not limited thereto.

The system info DB may record system events that occurred for each process on a time-by-time basis. The system info DB may identify important system events by analyzing the list of running processes, input/output statistics for each process, which processes consume the most system resources, etc. The system info aggregator may remove unimportant system events, based on system resource usages and system events. The system info aggregator may aggregate system events by integrating attributes of the system events, such as execution time and execution outputs, into system event units and may limit the number of system events per time span of a preset unit time. The system info aggregator may aggregate system usages by integrating system usages per time span of a preset unit time. The system info fact generator may generate triple facts from the aggregated system events and system usages, and the generated triple facts may be reflected in the system log knowledge graph.

The system log knowledge graph generation module 124 according to an embodiment of the disclosure may generate a system log knowledge graph in which results of aggregating system log data per system monitoring criterion are set as respective nodes. The system log knowledge graph generation module 124 may obtain statistically significant data by aggregating system log data per system monitoring criterion. The system log knowledge graph is a personal knowledge graph that aggregates and stores system log data for each system monitoring criterion at each preset time span. The system log data refers to records of data about system state information or an event occurred in a system, and may include usages of system resources such as CPU, memory, disk, network, and sensors, as well as system events. The system log knowledge graph may store a fact related to a system event and a system usage that belong to a time span based on time span information of a root node. The system monitoring criteria may be based on various perspectives such as hardware, processes, context information, time, and a user, or a combination thereof. For example, the system monitoring criteria may include “most active application,” “foreground display time,” “productivity level,” “user state,” “number of processes,” and “maximum duration.” The system log knowledge graph generation module 124 may perform an operation such as generating, updating, deleting, or retrieving a system log knowledge graph.

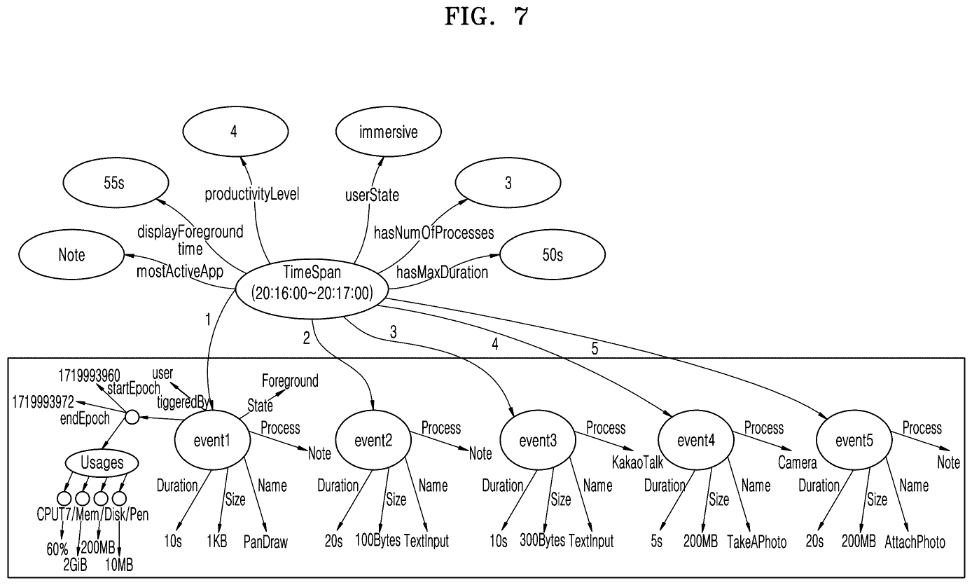

FIG. 7 is a diagram for describing a system log knowledge graph according to an embodiment of the disclosure.

Referring to FIG. 7, the user device 100 may generate a system log knowledge graph in which time span information of “20:16 to 20:17” is set as a root node and in which results of aggregating, per system monitoring criterion, system log data generated in the user device 100 during the one minute of the time span information are set as respective nodes. The system log data may include a system event and a system usage that occurred within a time span based on time span information of a preset time unit. In FIG. 7, the time span information is based on, but is not limited to, a one-minute time unit. The system log knowledge graph may reflect characteristics of system log data generated in the user device 100 during a time span based on time span information.

The user device 100 may generate a system log knowledge graph by connecting to the root node the results of aggregating, per system monitoring criterion, the system log data as the nodes. Referring to the example shown in FIG. 7, it may be seen that during one minute from “20:16 to 20:17,” the most active application in the user device 100 is a “note app,” and a time displayed in the foreground during the entire one minute is “55 seconds.” In addition, during the one minute from “20:16 to 20:17,” the number of processes executed in the user device 100 is “3,” and the max duration of a process is 50 seconds within the one minute. The user device 100 may infer state information such as a user's emotion or productivity or concentration level, based on the system log data. Referring to the example shown in FIG. 7, the user device 100 may infer that a productivity level in the user device 100 is approximately “4” and that the user's state is “immersive,” and may generate these as respective nodes in the system log knowledge graph.

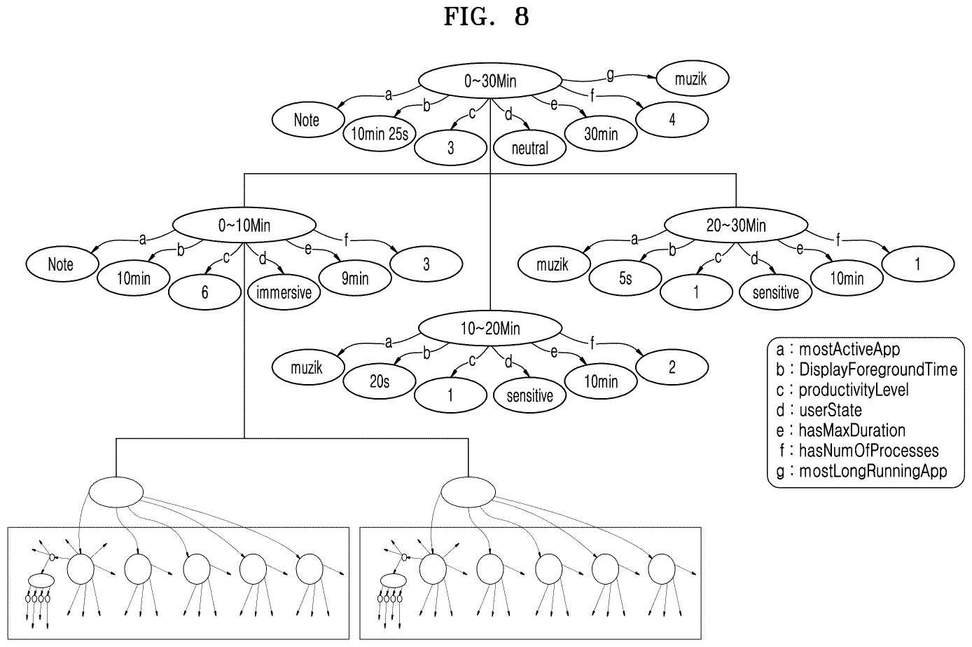

FIG. 8 is a diagram for describing integration of system log knowledge graphs, according to an embodiment of the disclosure.

Referring to FIG. 8, the user device 100 may generate a system log knowledge graph in which time span information of a time range of a minimum unit time which is one minute is set as a root node and in which results of aggregating, per system monitoring criterion, system log data collected within a time span based on the corresponding time span information are set as respective nodes connected to the root node. The user device 100 may integrate 10 system log knowledge graphs, each having time span information of one minute as a root node, and generate one system log knowledge graph in which time span information of ten minutes is set as a root node. In other words, the user device 100 may generate a system log knowledge graph in which time span information of a time range equal to the sum of time spans of shorter time-range time span information is set as a root node and in which results of integrating system log data collected within time spans based on the shorter time-range time span information, and of aggregating, per system monitoring criterion, the system log data, are set as respective nodes connected to the root node.

The user device 100 may integrate 10 system log knowledge graphs each corresponding to time span information of one minute, and may generate one system log knowledge graph corresponding to time span information of 10 minutes. The user device 100 may integrate three system log knowledge graphs each corresponding to the time span information of 10 minutes, and may generate one system log knowledge graph corresponding to time span information of 30 minutes. The user device 100 may integrate two system log knowledge graphs each corresponding to time span information of 30 minutes, and may generate one system log knowledge graph corresponding to time span information of an hour. In this manner, a system log knowledge graph with a hierarchical structure may be generated, in which a system log knowledge graph corresponding to shorter time-range time span information constitutes a lower layer, and a system log knowledge graph corresponding to time span information of a time range equal to the sum of time spans of shorter time-range time span information constitutes an upper layer. The higher the layer of a knowledge graph, the more it may reflect characteristics of system log data.

Referring to FIG. 8, it may be seen that a system log knowledge graph at the lowermost layer has time span information of one minute which is a time range of a minimum unit, and a system log knowledge graph of the uppermost layer has time span information of 30 minutes. Referring to the example shown in FIG. 8, it may be seen that the most active application in the user device 100 was a “note app,” and a time displayed in the foreground during the entire 30 minutes was “10 minutes, 25 seconds.” It may be seen that, during a time span from the 10th minute to the 30th minute, the most active app is “muzik app,” but “muzik app” was running while a screen was off, with its display time in the foreground being only 20 seconds and 5 seconds, respectively. In addition, it may be seen that a user's emotional state was “immersive” during the first 10 minutes, but the user's emotional state was “sensitive” during the 20 minutes from the 10th minute to the 30th minute, and thus, the user's overall emotional state during the entire 30 minutes was inferred to be “neutral.” In addition, it may be seen that the productivity level was “6” during the first 10 minutes, but the productivity level was “1” during the 20 minutes from the 10th minute to 30th minute, and thus, the productivity level during the entire 30 minutes was inferred as “3.” In addition, it may be seen that the application that was executed the longest during the entire 30 minutes was “muzik app.”

When a system log knowledge graph with such a hierarchical structure is provided, the user device 100, in order to identify characteristics of system log data corresponding to particular time span information, does not need to individually identify characteristics of a plurality of pieces of system log data each corresponding to time span information of a preset unit time, but may instead identify characteristics of system log data corresponding to a longer time span via a system log knowledge graph at a higher layer.

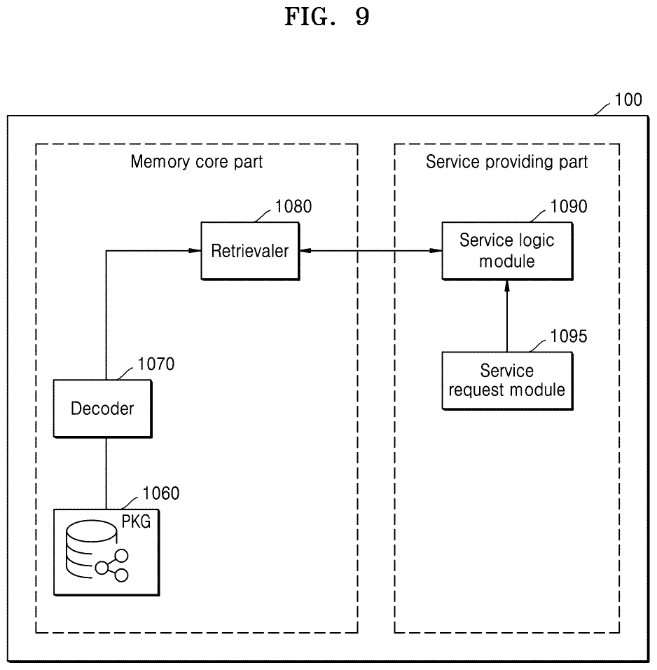

FIG. 9 is a diagram for describing an operation performed by the user device 100 to provide a personal knowledge graph-based service, according to an embodiment of the disclosure.

According to an embodiment of the disclosure, in a service providing part of the user device 100, a service logic module 1090 may execute a preset service, according to a user input via a service request module 1095. The service request module 1095 may receive a user input, such as a request to execute a preset application, a search word input, or a touch on a user interface screen for setting a particular item, character, number or time span. For example, the service logic module 1090 may request a retrievaler 1080 for a related personal knowledge graph or user data of the personal knowledge graph, according to a request to execute a preset application or a search word input which is input from a user. The service logic module 1090 may provide the preset service by using the personal knowledge graph based on user data having a co-relationship or the user data obtained from the personal knowledge graph.

In a memory core part of the user device 100, the retrievaler 1080 may retrieve a personal knowledge graph stored in the storage 1060 or may search for user data included in the personal knowledge graph. The retrievaler 1080 may include a retrieve engine or a search engine. The retrievaler 1080 may retrieve, from the storage 1060, personal knowledge graphs for each date, or personal knowledge graphs during a particular date or time span, and may transmit a retrieval result to the service logic module 1090. The retrievaler 1080 may search for, in the storage 1060, a personal knowledge graph corresponding to a search word or a query, or user data included in the personal knowledge graph, and may transmit a search result to the service logic module 1090. The retrievaler 1080 may identify an internationalized resource identifier (IRI) of a representative term with respect to an input search word by using an embedding vector comparison method or a synonym dictionary DB. The retrievaler 1080 may configure a query using the IRI, and may receive a result of the query with respect to a personal knowledge graph from the storage 1060.

A decoder 1070 performs an inverse role of the encoder 1050 of FIG. 2. The decoder 1070 may obtain data usable in the service logic module 1090, from structured data obtained from the personal knowledge graph.

When the user's interest within a particular time span is identified, the user device 100 may provide an effective service via personalization based on the user's interest. Hereinafter, provided is a detailed description of a method by which the user device 100 infers a user's interest by using a system log knowledge graph and a user log knowledge graph, to provide a preset service when the system log knowledge graph and the user log knowledge graph are stored in the form of a personal knowledge graph in the storage 1060.

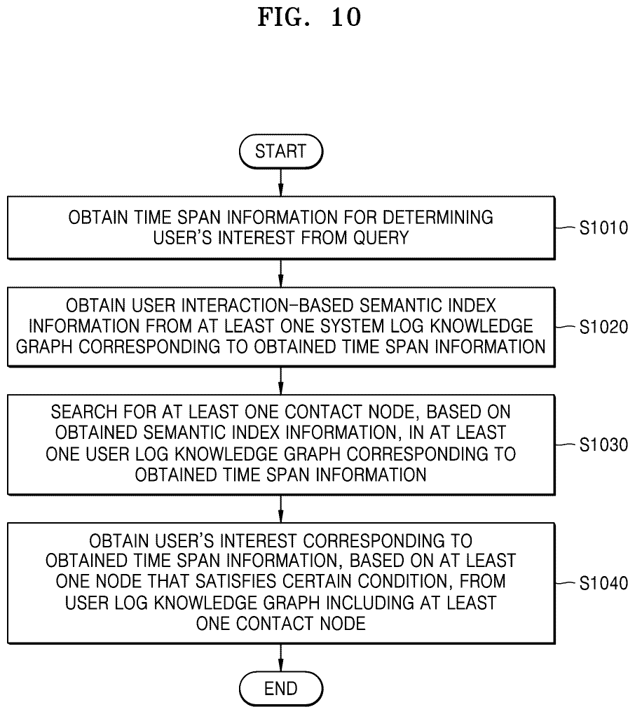

FIG. 10 is a flowchart for describing a method of inferring a user's interest, the method being performed by the user device 100, according to an embodiment of the disclosure.

The user device 100 according to an embodiment of the disclosure may obtain time span information for determining a user's interest from a query (S1010).

The query may be generated during a process in which the user device 100 provides a service. The query may be generated by a query generation model of the user device 100, according to the type of service being provided to the user, a user input, or the user's state or situation. For example, in an environment in which the user device 100 provides a first service to the user, when there is a request from the user using the first service or an interaction between the user device 100 and the user, the user device 100 may generate a query, based on at least one of the type of the first service, a user input, or the user's state or situation.

The query may be in the form of a request for the user's interest over a particular time span. For example, the query may be in the form of a question to ask what was “the user's interest over a past month.” Although the query is in the form of requesting a preset service, the user device 100 may need to identify the user's interest over a particular time span to provide the preset service. For example, when there is a query requesting a music recommendation service, such as “Please recommend a song,” the user device 100 may check whether there are any singers or songs that match the user's interest. When the user's interest related to songs is identified, the user device 100 may provide a personalized song recommendation.

The user device 100 may determine a time span during which information about the user's interest is required, by analyzing the query. The user device 100 may obtain time span information for determining the user's interest, by analyzing the query. The time span for determining the user's interest may be set differently depending on the content of the query. For example, when the query is related to the user's interest for today, the time span for determining the user's interest may be set to today. When the query is related to the user's interest over a past month, the time span for determining the user's interest may be set to the past month. When it is impossible to specify the time span information for determining the user's interest, the time span information for determining the user's interest may be determined based on a default value.

The user device 100 according to an embodiment of the disclosure may obtain user interaction-based semantic index information (hereinafter, referred to as semantic index information) from at least one system log knowledge graph corresponding to the time span information for determining the user's interest (S1020).

A system log knowledge graph may be a personal knowledge graph in which results of aggregating, per system monitoring criterion, system log data collected within a time span based on time span information of a predefined time range are set as respective nodes. The predefined time range may be one minute, 10 minutes, an hour, or one day, but is not limited thereto. A system log knowledge graph corresponding to the time span information for determining the user's interest may mean that a time point, at which system log data of the system log knowledge graph is generated, belongs to a time span based on the time span information for determining the user's interest.

The semantic index information may correspond to guidance information about searching for nodes of a personal knowledge graph to obtain information about the user's interest or intention. Because the user's interest or intention is reflected in an interaction between the user and the user device 100, such as “what” the user has used on the user device 100, “how frequently” or “how long” it has been used, and “what inputs have been made by the user,” in an embodiment of the disclosure, the user interaction-based semantic index information may be used to infer the user's interest. Because those regarding the interaction between the user and the user device 100 are all stored as system log data within the user device 100, the semantic index information may be information that is obtained from at least one node of a system log knowledge graph generated using the system log data.

The semantic index information may be utilized as filter condition information used to determine the user's interest. The user device 100 may select a section corresponding to the semantic index information within the entire time span for determining the user's interest. For example, the user device 100 may obtain information about a particular section for obtaining the user's interest, by selecting, from among at least one system log knowledge graph belonging to particular time span information, a system log knowledge graph having a value corresponding to the semantic index information. Accordingly, the amount of data that has to be searched for by the user device 100 is significantly reduced.

In an embodiment of the disclosure, the user device 100 may obtain system monitoring criteria used to determine the user's interest from the at least one system log knowledge graph, according to a preset rule. The user device 100 may obtain the semantic index information from the at least one system log knowledge graph, based on at least one node corresponding to the system monitoring criteria obtained according to the preset rule. According to an embodiment of the disclosure, the system monitoring criteria used to determine the user's interest may be preset by a manufacturer of the user device 100 or by the user of the user device 100, based on a relationship between system monitoring criteria. For example, when a first system monitoring criterion is “most active application,” a second system monitoring criterion is “productivity level,” and a correlation between the type of application and the productivity is recognized, the first system monitoring criterion and the second system monitoring criterion may be preset as system monitoring criteria used to determine the user's interest. Accordingly, the user device 100 may obtain semantic index information, based on a node corresponding to the first system monitoring criterion and a node corresponding to the second system monitoring criterion. According to an embodiment of the disclosure, the system monitoring criteria used to determine the user's interest may be determined according to importance levels of the system monitoring criteria themselves or values of nodes corresponding to the system monitoring criteria. When a particular system monitoring criterion has the highest importance level, the particular system monitoring criterion may be preset as a system monitoring criterion used to determine the user's interest. The user device 100 may set an importance level for each system monitoring criterion. For example, when “most active application” is set as an important system monitoring criterion that needs to be checked, the user device 100 may obtain semantic index information, based on a node corresponding to a system monitoring criterion, i.e., “most active application.” When a value of a node corresponding to an arbitrary system monitoring criterion is greater than a preset threshold or corresponds to a particular value, the arbitrary system monitoring criterion may be preset as a system monitoring criterion used to determine the user's interest. The user device 100 may set a threshold or a particular value for each system monitoring criterion. For example, when a value of a node corresponding to a system monitoring criterion, i.e., “productivity level,” is 8 or higher, the user device 100 may select “productivity level” as a system monitoring criterion used to determine the user's interest, and may also select another system monitoring criterion (for example, most active application) that has a correlation.

In an embodiment of the disclosure, the user device 100 may obtain at least one system monitoring criterion used to determine the user's interest, according to the content of the query, by using a system monitoring criterion selection model trained based on past history information used to determine the semantic index information. The user device 100 may obtain the semantic index information from at least one system log knowledge graph, based on at least one node corresponding to the at least one system monitoring criterion obtained by using the system monitoring criterion selection model. The system monitoring criterion selection model may be a large language model. According to an embodiment of the disclosure, the user device 100 may obtain the at least one system monitoring criterion that needs to be primarily considered when determining the user's interest from among a plurality of system monitoring criteria according to the content of the query, by using the system monitoring criterion selection model. The system monitoring criterion selection model may analyze the given system monitoring criteria and the query, and may determine which combination of system monitoring criteria may be used to infer the user's interest, according to the content of the query. As a determination result, the system monitoring criterion selection model may output a combination of system monitoring criteria that is most suitable for inferring the user's interest.

In an embodiment of the disclosure, when the time span information for determining the user's interest includes a combination of a plurality of pieces of sub-time span information of a predefined time range, the user device 100 may determine semantic index information in a system log knowledge graph corresponding to each sub-time span information. The time span information for determining the user's interest may include a combination of a plurality of pieces of sub-time span information of time ranges that are equal to or different from each other. For example, when the time span information for determining the user's interest is “today 15:00-17:21” and the predefined time ranges are “an hour,” “10 minutes,” and “one minute,” the sub-time span information may be “today 15:00-16:00,” “today 16:00-17:00,” “today 17:00-17:10,” “today 17:10-17:20,” and “today 17:20-17:21.”

In an embodiment of the disclosure, the user device 100 may search for at least one node corresponding to at least one system monitoring criterion used to determine the interest, in a system log knowledge graph corresponding to sub-time span information. The system log knowledge graph corresponding to the sub-time span information may be a system log knowledge graph in which sub-time span information is set as a root node and in which results of aggregating, per system monitoring criterion, system log data collected within a time span based on the sub-time span information are set as respective nodes connected to the root node. The user device 100 may determine semantic index information, based on the at least one node searched for in the system log knowledge graph corresponding to the sub-time span information.

In an embodiment of the disclosure, upper-level sub-time span information may include a combination of a plurality of pieces of lower-level sub-time span information having a smaller time range. The upper-level sub-time span information may include a combination of a plurality of pieces of lower-level sub-time span information having the same time range. For example, in an example in which the time span information for determining the user's interest is “today 15:00-17:21,” upper-level sub-time span information of “today 15:00-16:00” may include a combination of a plurality of pieces of lower-level sub-time span information of “today 15:00-15:10,” “today 15:10-15:20,” “today 15:20-15:30,” “today 15:30-15:40,” “today 15:40-15:50,” and “today 15:50-15:60.” In addition, lower-level sub-time span information (for example, lower-level sub-time span information of “today 15:00-15:10”) of a 10-minute unit may include a combination of 10 pieces of lower-level sub-time span information of a one-minute unit. The lowest-level sub-time span information may have a time range corresponding to a preset time unit (for example, a time unit of one minute).

In an embodiment of the disclosure, the system log knowledge graph corresponding to the sub-time span information may be a generated hierarchical structure by setting upper-level sub-time span information, which has a time range equal to the sum of time spans of lower-level sub-time span information, as a root node and setting results of integrating system log data collected within a time span based on the lower-level sub-time span information, and of aggregating, per system monitoring criterion, the system log data, as respective nodes connected to the root node of the upper-level sub-time span information, and by connecting the root node of the upper-level sub-time span information to root nodes of the lower-level sub-time span information. In order to obtain semantic index information from the system log knowledge graph corresponding to the sub-time span information, which has the hierarchical structure, the user device 100 may obtain semantic index information from a system log knowledge graph corresponding to sub-time span information of each layer, from the uppermost layer to the lowermost layer of the system log knowledge graph corresponding to the sub-time span information, or may stop searching into a lower layer of a system log knowledge graph. The user device 100 may obtain semantic index information from a system log knowledge graph corresponding to lower-level sub-time span information, based on at least one system monitoring criterion and semantic index information, which are used to determine the interest in a system log knowledge graph corresponding to upper-level sub-time span information. To obtain the semantic index information from the system log knowledge graph corresponding to the lower-level sub-time span information, the user device 100 may use a system monitoring criterion identical to the at least one system monitoring criterion used to determine the interest in the system log knowledge graph corresponding to the upper-level sub-time span information.

The user device 100 may determine a similarity between the semantic index information obtained from the system log knowledge graph corresponding to the lower-level sub-time span information and the semantic index information obtained from the system log knowledge graph corresponding to the upper-level sub-time span information. The user device 100 may treat the semantic index information corresponding the lower-level sub-time span information as valid when the similarity between the semantic index information obtained from the system log knowledge graph corresponding to the lower-level sub-time span information and the semantic index information obtained from the system log knowledge graph corresponding to the upper level sub-time span information does satisfy a preset criterion. The user device 100 may treat the semantic index information corresponding to the lower-level sub-time span information as invalid when the similarity between the semantic index information obtained from the system log knowledge graph corresponding to the lower-level sub-time span information and the semantic index information obtained from the system log knowledge graph corresponding to the upper level sub-time span information does not satisfy the preset criterion, and may stop searching into a lower layer of a system log knowledge graph. Because the semantic index information obtained from the system log knowledge graph corresponding to the upper-level sub-time span information represents a user interaction over a longer time range than the semantic index information obtained from the system log knowledge graph corresponding to the lower-level sub-time span information, when the similarity between the semantic index information corresponding to the upper-level sub-time span information and the semantic index information corresponding to the lower-level sub-time span information does not satisfy the preset criterion, the user device 100 may ignore the semantic index information corresponding to the lower-level sub-time span information.

The user device 100 according to an embodiment of the disclosure may search for at least one contact node, based on the semantic index information obtained from the at least one system log knowledge graph, in at least one user log knowledge graph corresponding to the time span information for determining the user's interest (S1030).

A user log knowledge graph may be a personal knowledge graph in which entities related to a user's activity information based on user log data are set as respective nodes and in which a relationship between the entities is represented. The entities related to the user's activity information refers to a fact extracted from an event generated when the user performs an action on the user device 100, and may include information about an application executed in the user device 100, application execution outputs, and words extracted from the execution outputs, or inferred materials or topics. The user log knowledge graph may be refined to represent a relationship between keywords at the level of the user's action information.

The user device 100 according to an embodiment of the disclosure may select a user log knowledge graph that is most relevant to the user's interest from among a plurality of user log knowledge graphs belonging to the time span information for determining the user's interest, by utilizing semantic index information obtained based on at least one node of a system log knowledge graph.

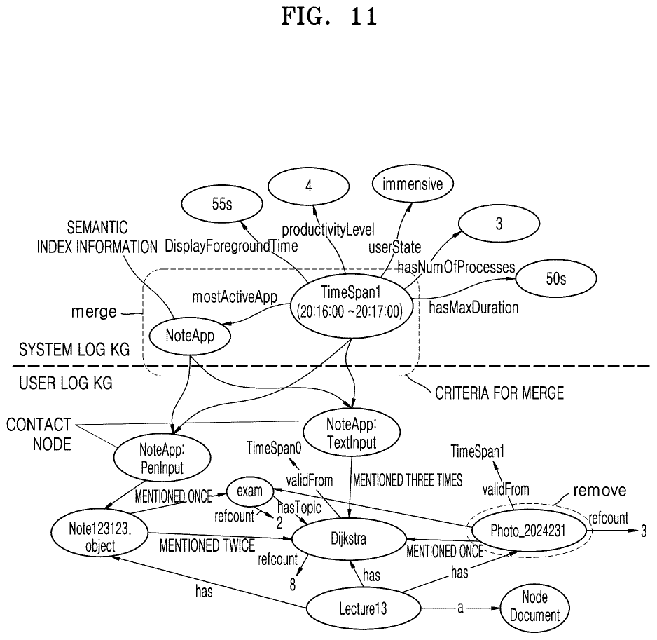

In an embodiment of the disclosure, the user device 100 may search for at least one contact node, based on semantic index information obtained based on at least one node of a system log knowledge graph, in at least one user log knowledge graph. A contact node refers to a node that corresponds to a contact point through which a second personal knowledge graph may be accessed from a node in a first personal knowledge graph, when the first personal knowledge graph and the second personal knowledge graph are different from each other. For example, when semantic index information corresponding to first time span information is “ABC” application information, the user device 100 may search for, in at least one user log knowledge graph corresponding to the first time span information, a node having the “ABC” application information as a contact node. Hereinafter, referring to FIG. 11, a detailed description is provided.

FIG. 11 is a diagram for describing a connection relationship between a system log knowledge graph and a user log knowledge graph, according to an embodiment of the disclosure.

Referring to FIG. 11, there is a system log knowledge graph in which time span information of “20:16 to 20:17” is set as a root node and in which results of aggregating, per system monitoring criterion, system log data collected from the user device 100 during the one minute of the time span information are set as respective nodes. In addition, there is a user log knowledge graph in which entities related to a user's activity information based on user log data generated by execution of a note application and a camera application in the user device 100 during the time span information are set as respective nodes and in which a relationship between the entities is represented. Referring to the user log knowledge graph shown in FIG. 11, it may be seen that the user executed the note application, generated an output via a pen input, named “Note123123.object,” mentioning the keyword “exam” and “Dijkstra”, and generated an output via a text input mentioning the keyword “Dijkstra.” In addition, it may be seen that the user generated a picture named “photo_2024231” mentioning the keywords “exam” and “Dijkstra” and included in “Lecture13,” via taking a picture using a camera application.

Referring to FIG. 11, the user device 100 may search for at least one contact node in the user log knowledge graph by utilizing, as semantic index information, “note application” obtained based on a node corresponding the most active application from the system log knowledge graph. Because the semantic index information is “note application,” the user device 100 may search for a node having “note application” information as a contact node, in the user log knowledge graph.

In addition, as shown in FIG. 11, the user device 100 may connect the system log knowledge graph and the user log knowledge graph together by using the semantic index information, which is obtained from the system log knowledge graph, and the root node which is preset time span information, as criteria for a merge, and may merge the system log knowledge graph of the root node with the user log knowledge graph including the contact node having the same information as the semantic index information. The user device 100 may generate an interest knowledge graph representing the user's interest, by merging the system log knowledge graph based on the system log data with the user log knowledge graph based on the user log data. The user device 100 may remove a node with low importance during a process of merging a plurality of knowledge graphs. As shown in FIG. 11, a node of an entity related to activity information such as “taking a picture using a camera app” may be removed from the user log knowledge graph. The user device 100 may store the merged knowledge graph as the interest knowledge graph and may obtain the user's interest from the interest knowledge graph, based on at least one node that satisfies a preset condition.

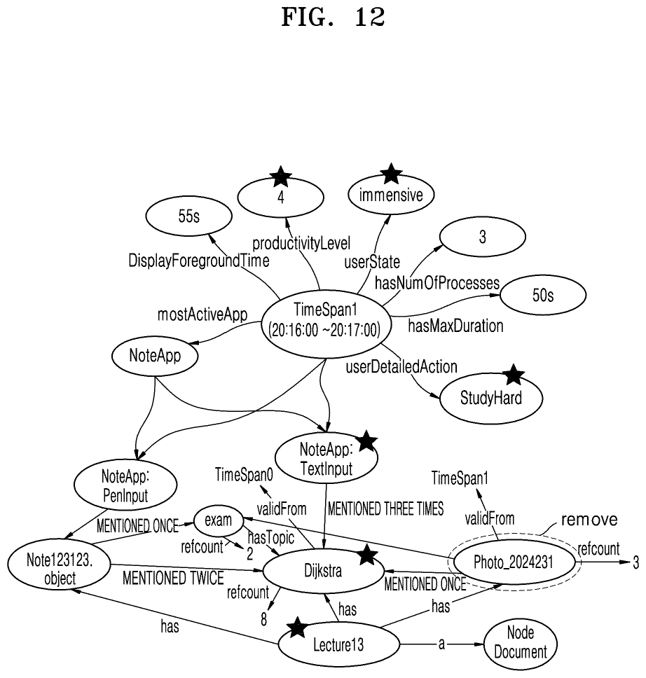

FIG. 12 is a diagram for describing an interest knowledge graph obtained by merging a system log knowledge graph with a user log knowledge graph, according to an embodiment of the disclosure.

As described above with reference to FIG. 11, an interest knowledge graph may be generated by identifying a contact node, which corresponds to a contact point, using semantic index information and information about time span information, with respect to heterogeneous personal knowledge graphs, and by connecting and merging the two knowledge graphs. In this case, the interest knowledge graph may further include a node representing inferred activity information as the user's state within time span information of a preset unit time, based on nodes of a result obtained by merging the system log knowledge graph and the user log knowledge graph.

Referring to FIG. 12, the user device 100 may infer activity information of “study hard” as the user's state within time span information of a preset unit time, from values of a node of “productivity level” and a node of “user state” in the system log knowledge graph which is part of the interest knowledge graph, and from the keywords “Dijkstra” and “Lecture13” in the user log knowledge graph which is part of the interest knowledge graph. Accordingly, the interest knowledge graph may further include a node representing the inferred activity information.

Referring back to FIG. 10, in an embodiment of the disclosure, when the time span information for determining the user's interest includes a combination of a plurality of pieces of sub-time span information of a predefined time range, the user device 100 may search for at least one contact node, based on semantic index information corresponding to sub-time span information, in at least one user log knowledge graph. For example, when semantic index information corresponding to sub-time span information is “XYZ” application information, the user device 100 may search for a contact node having the same application information as the “XYZ” application information, in at least one user log knowledge graph corresponding to the sub-time span information.

When a system log knowledge graph corresponding to sub-time span information has a hierarchical structure, the user device 100 may search for at least one contact node, based on semantic index information corresponding to sub-time span information of the lowermost layer of a preset unit time, in at least one user log knowledge graph generated for each preset unit time. For example, when the semantic index information corresponding to the sub-time span information of the lowermost layer of a preset unit time is second application information, the user device 100 may search for a contact node having the same application information as the second application information, in at least one user log knowledge graph generated for each preset unit time.

The user device 100 according to an embodiment of the disclosure may obtain the user's interest corresponding to the time span information for determining the user's interest, based on at least one node that satisfies a preset condition, from a user log knowledge graph including the at least one contact node (S1040).

In an embodiment of the disclosure, the user device 100 may obtain an entity of the at least one node as the user's interest from the at least one user log knowledge graph by applying, to each node, a weight based on a validity within a time span based on the time span information for determining the user's interest and a relevance to other nodes. The validity of a node within the time span based on the time span information for determining the user's interest refers to a time span during which the node is valid as the interest, within the entire time span. For example, the validity of the node may be determined based on how long an entity of the node persists as the interest and how frequently it is selected as the interest during a time span based on the time span information for determining the user's interest. The relevance of each node to other nodes in a user log knowledge graph refers to the extent to which a corresponding node influences other nodes or how closely it is related to them. For example, the relevance of the corresponding node to other nodes may be determined based on the number of hops away from the at least one contact node to the corresponding node (or the number of hops away from a root node of a system log knowledge graph to the corresponding node), the number of times the corresponding node is referenced by other nodes in the at least one user log knowledge graph, and a similarity between the user's action inferred from the at least one system log knowledge graph and a category of the corresponding node.

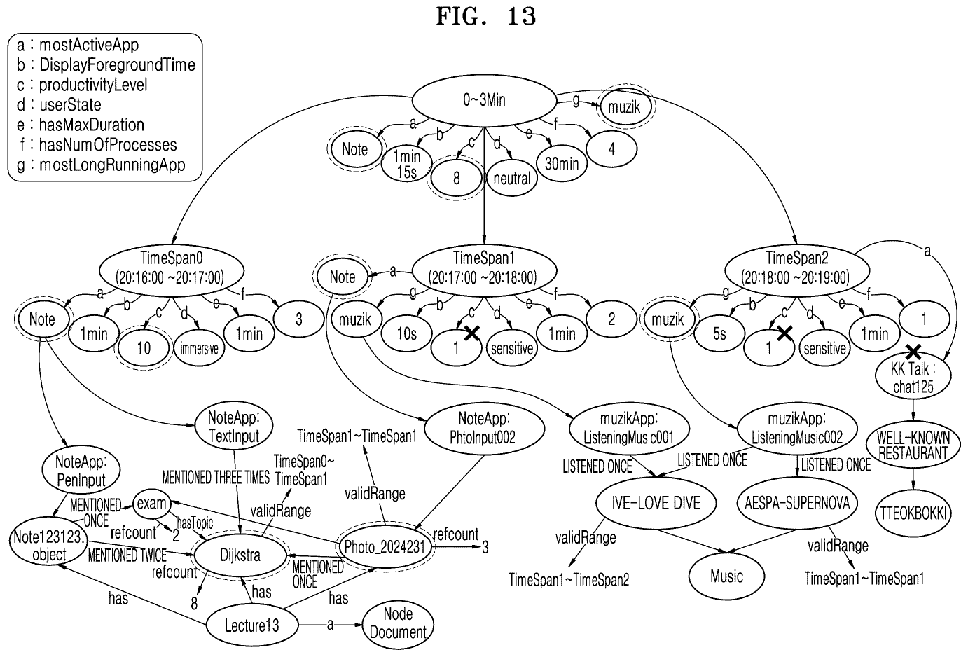

FIG. 13 is a diagram for describing a process of inferring a user's interest by using a system log knowledge graph and a user log knowledge graph, according to an embodiment of the disclosure.

Referring to FIG. 13, there are a system log knowledge graph having time span information of a time range of three minutes as a root node, and three system log knowledge graphs, each having time span information of a time range of one minute (hereinafter, referred to as sub-time span information) as a root node, which together constitute the three minutes. The root node of each system log knowledge graph corresponding to the sub-time span information is connected to the root node of the system log knowledge graph corresponding to the time span information of three minutes, which is upper-level time span information. Each system log knowledge graph corresponding to the sub-time span information is connected to at least one user log knowledge graph.

When a query requesting a user's interest is input, the user device 100 obtains time span information for determining the user's interest from the query. FIG. 13 illustrates a case in which the time span information for determining the user's interest is three minutes.

The user device 100 may obtain user interaction-based semantic index information from the system log knowledge graph corresponding to the time span information of three minutes, which is the uppermost root node. In FIG. 3, assuming that a total of three things, i.e., “most active application,” “productivity level,” and “most long running application,” are determined as system monitoring criteria used to determine the user's interest, the user device 100 may search for nodes corresponding to respective system monitoring criteria and, based on the searched nodes, determine user interaction-based semantic index information. In other words, in the system log knowledge graph corresponding to the three-minute time span information, “note app,” “productivity level 8,” and “muzik app” may be obtained as semantic index information, according to a total of three criteria, i.e., “most active application,” “productivity level,” and “most long running application.”

The user device 100 may obtain semantic index information from each system log knowledge graph corresponding to the sub-time span information of one minute, based on at least one system monitoring criterion and semantic index information used to determine the interest in the system log knowledge graph corresponding to the time span information of three minutes. Referring to FIG. 13, in a system log knowledge graph in which sub-time span information of “20:16 to 20:17”, i.e., “TimeSpan0,” is set as a root node, “note app” and “productivity level 10” may be obtained as semantic index information, according to a total of three criteria, i.e., “most active application,” “productivity level,” and “most long running application.” In contrast, in a system log knowledge graph in which sub-time span information of “20:17 to 20:18”, i.e., “TimeSpan1,” is set as a root node, “note app,” “productivity level 1,” and “muzik app” may be obtained as semantic index information, according to a total of three criteria, i.e., “most active application,” “productivity level,” and “most long running application,” but it may be seen that a similarity with the semantic index information obtained from the system log knowledge graph corresponding to the time span information of three minutes, which is an upper-level root node, does not satisfy a preset criterion. In particular, because “productivity level 8” obtained from the system log knowledge graph corresponding to the time span information of three minutes, which is the upper-level root node, is not similar to “productivity level 1” obtained from the system log knowledge graph in which “TimeSpan1” is set as the root node, the user device 100 may treat the semantic index information corresponding to the sub-time span information of “TimeSpan1” as invalid and may stop searching into a lower layer of a system log knowledge graph or a connected user log knowledge graph. In a system log knowledge graph in which sub-time span information of “20:18 to 20:19,” i.e., “TimeSpan2,” is set as a root node, “KK Talk app,” “productivity level 1,” and “muzik app” may be obtained as semantic index information, but “productivity level 8” obtained from the system log knowledge graph corresponding to the time span information of three minutes, which is the upper-level root node, is not similar to “productivity level 1” obtained from the system log knowledge graph in which “TimeSpan2” is set as the root node, and thus, the user device 100 may treat the semantic index information corresponding to the sub-time span information of “TimeSpan2” as invalid and may stop searching into a lower layer of a system log knowledge graph or a connected user log knowledge graph.

The user device 100 may search for at least one contact node, based on “note app” which is the semantic index information obtained from the system log knowledge graph in which “TimeSpan0” is set as the root node, in at least one user log knowledge graph corresponding to the time span information for determining the user's interest. Referring to FIG. 13, when “note app:pen input” and “note app:text input” are searched for as contact nodes in a user log knowledge graph, the user log knowledge graph may obtain the user's interest corresponding to the time span information for determining the user's interest, based on at least one node that satisfies a preset condition, from the user log knowledge graph including “note app:pen input” and “note app:text input” which are the contact nodes. The user device 100 may obtain the keyword “Dijkstra” as the user's interest corresponding to the time span information for determining the user's interest because a node corresponding to the keyword “Dijkstra” is one hop away from a contact node (or two hops away from the root node of “TimeSpan0”), is the most frequently referenced node, being referenced eight times by other nodes, and is valid over two time spans from “TimeSpan0” to “TimeSpan1.” In the case of a node corresponding to “photo_2024231”, which is an output obtained via capture of a picture, searching for the node as a contact node connected to the system log knowledge graph corresponding to the sub-time span information of “TimeSpan1” failed, but, due to its co-relationship and temporal adjacency-based relevance with the node of the keyword “Dijkstra”, the node may be obtained as the user's interest corresponding to the next priority.

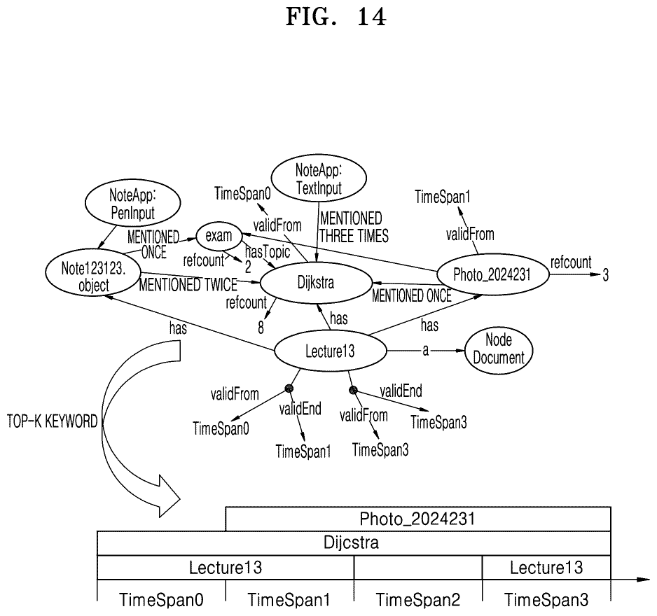

FIG. 14 is a diagram for describing a method of obtaining a user's interest when keywords corresponding to a plurality of entities are obtained, the method being performed by the user device 100, according to an embodiment of the disclosure.

In an embodiment of the disclosure, the user device 100 may obtain keywords corresponding to a plurality of entities from a plurality of nodes of a user log knowledge graph. The user device 100 may determine prioritize the keywords by applying, to each of the keywords, a weight based on a validity of a node corresponding to a keyword and a relevance to other nodes, and may prioritize interests accordingly.

Referring to FIG. 14, the user device 100 obtained a total of three keywords that are “Lecture13,” “Dijkstra,” and “photo_2024231,” which correspond to interests.

Form the perspective of validity of a node corresponding to a keyword, it may be seen that “Lecture13” is valid for a total of three time spans, from “TimeSpan1,” “TimeSpan2,” and “TimeSpan3,” “Dijkstra” is valid for a total of four time spans, from “TimeSpan0” to “TimeSpan3,” and “photo_2024231” is valid for a total of three time spans, from “TimeSpan1” to “TimeSpan3.” When a plurality of pieces of time span information from “TimeSpan0” to “TimeSpan3” has the same time range, a node corresponding to “Dijkstra” has persisted for the longest time span, and therefore has the highest validity and may be assigned a higher weight. Nodes respectively corresponding to “Lecture13” and “photo_2024231” are each valid for three time spans.

From the perspective of relevance to other nodes, it may be seen that “Dijkstra” is referenced eight times by other nodes and corresponds to one hop away from its contact node, and “photo_2024231” is referenced three times by other nodes and corresponds to two hops away from its contact node. “Lecture13” corresponds to two hops away from its contact node, and when “Lecture13” is referenced four or more times by other nodes, its relevance to other nodes is higher than that of “photo_2024231,” and therefore, a higher weight may be applied, whereas when “Lecture13” is referenced fewer than three times by other nodes, its relevance to other nodes is lower than that of “photo_2024231,” and therefore, a lower weight may be applied. Because “photo_2024231” and “Lecture13” have the same node validity and the same number of hops away from their respective contact nodes, the priority of the two keywords may be determined based on the number of times the corresponding nodes are referenced by other nodes, and the priority of the interests may vary.

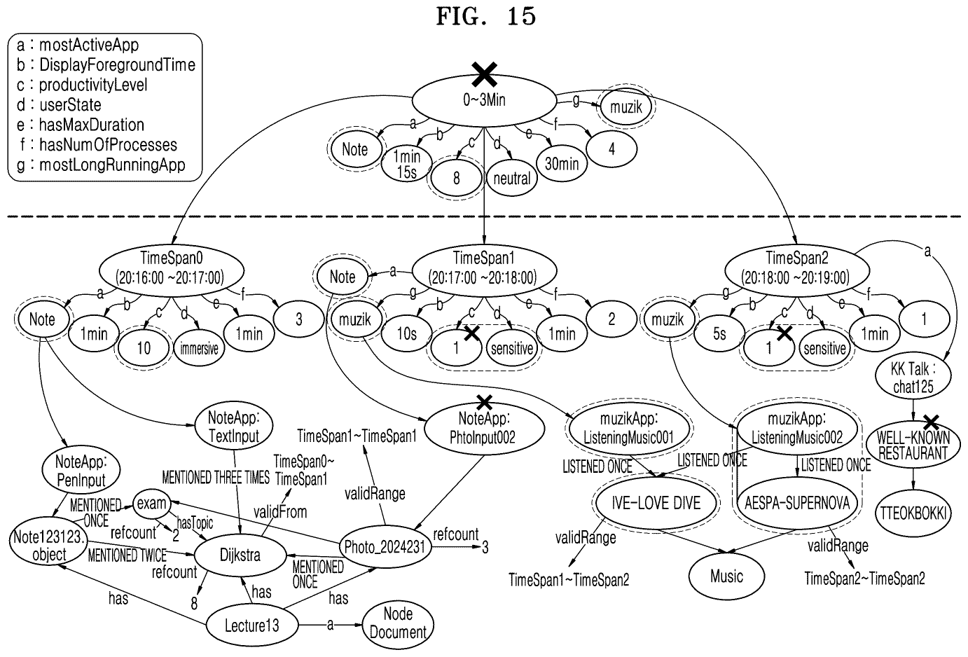

FIG. 15 is a diagram for describing a process of inferring a user's interest by using a system log knowledge graph and a user log knowledge graph, according to an embodiment of the disclosure.

Referring to FIG. 15, there is a system log knowledge graph having time span information of a time range of three minutes as a root node, and three system log knowledge graphs, each having time span information of a time range of one minute (hereinafter, referred to as sub-time span information) as a root node, which together constitute the three minutes. The root node of each system log knowledge graph corresponding to the sub-time span information is connected to the root node of the system log knowledge graph corresponding to the time span information of three minutes, which is upper-level time span information. Each system log knowledge graph corresponding to the sub-time span information is connected to at least one user log knowledge graph.

When a query requesting a user's interest is input, the user device 100 obtains time span information for determining the user's interest from the query. FIG. 15 illustrates a case in which the time span information for determining the user's interest is a total of two minutes, from 20:17 to 20:19.

The system log knowledge graph corresponding to the time span information of three minutes, which is the uppermost root node, includes system data corresponding to “TimeSpan0” from 20:16 to 20:17, and thus, without searching for the system log knowledge graph corresponding to the time span information of three minutes, the user device 100 may obtain user interaction-based semantic index information from a system log knowledge graph corresponding to “TimeSpan1” and a system log knowledge graph corresponding to “TimeSpan2”, which are the system log knowledge graphs of lower layers. In FIG. 15, assuming that a total of four, i.e., “most active app,” “productivity level,” “user state,” and “most long running app,” are determined as system monitoring criteria used to determine the interest, the user device 100 may search for nodes corresponding to respective system monitoring criteria and, based on the searched nodes, determine user interaction-based semantic index information.

In the system log knowledge graph corresponding to “TimeSpan1,” nodes of “note app,” “productivity level 1,” “sensitive,” and “muzik app,” which respectively correspond to a total of four criteria, i.e., “most active app,” “productivity level,” “user state,” and “most long running app,” may be searched for. However, “note app” may not be determined as index information because it does not have compatibility with the other searched nodes. Therefore, the user device 100 may determine “muzik app” as semantic index information, and may search for at least one contact node, based on “muzik app,” in the at least one user log knowledge graph corresponding to the time span information for determining the user's interest. Referring to FIG. 15, when “muzik app:listening music 1” is searched for as a contact node in a user log knowledge graph, the user device 100 may obtain the user's interest corresponding to the time span information for determining the user's interest, based on at least one node that satisfies a preset condition, from the user log knowledge graph including “muzik app:listening music 1” which is the contact node. Because a node corresponding to the keyword “IVE-LOVE DIVE” is one hop away from the contact node (or two hops away from the root node of “TimeSpan0”) and is valid for two time spans of “TimeSpan1” and “Timespan2,” the keyword “IVE-LOVE DIVE” may be obtained as the user's interest corresponding to the time span information for determining the user's interest.

In the system log knowledge graph corresponding to “TimeSpan2,” nodes of “KK Talk app,” “productivity level 1,” “sensitive,” and “muzik app,” which respectively correspond to a total of four criteria, i.e., “most active app,” “productivity level,” “user state,” and “most long running app,” may be searched for. However, “KK Talk app” may not be determined as index information because it does not have compatibility with the other searched nodes. Therefore, the user device 100 may determine “muzik app” as semantic index information, and may search for at least one contact node, based on “muzik app,” in the at least one user log knowledge graph corresponding to the time span information for determining the user's interest. Referring to FIG. 15, when “muzik app:listening music 2” is searched for as a contact node in a user log knowledge graph, the user device 100 may obtain the user's interest corresponding to the time span information for determining the user's interest, based on at least one node that satisfies a preset condition, from the user log knowledge graph including “muzik app:listening music 2” which is the contact node. Because a node corresponding to the keyword “AESPA-SUPERNOVA” is one hop away from the contact node (or two hops away from the root node of “TimeSpan0”) and is valid for a time span of “TimeSpan2,” the keyword “AESPA-SUPERNOVA” may be obtained as the user's interest corresponding to the time span information for determining the user's interest.

The keyword “IVE-LOVEDIVE” which is the interest obtained based on the semantic index information obtained from the system log knowledge graph corresponding to “TimeSpan1” has a longer validity than the keyword “AESPA-SUPERNOVA” which is the interest obtained based on the semantic index information obtained from the system log knowledge graph corresponding to “TimeSpan2,” and thus may become a higher-priority interest.

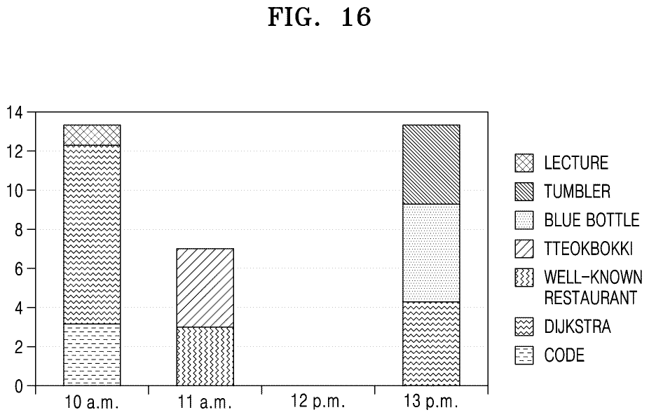

FIG. 16 is a diagram for describing a graph of keywords generated using a method of providing a user's interest corresponding to a preset time span to the user, the method being performed by the user device 100, according to an embodiment of the disclosure.

The user device 100 according to an embodiment of the disclosure may provide a chart representing keywords obtained as a user's interests, by time of day within a time span in which interests are determined. Referring to FIG. 16, it may be seen that the user device 100 has obtained a total of seven keywords, i.e., “lecture,” “tumbler,” “blue bottle,” “tteokbokki,” “well-known restaurant,” “Dijkstra,” and “code,” as the user's interests over four hours from 10:00 to 14:00. During one hour from 10:00, a total of three interests, i.e., “lecture,” “Dijkstra,” and “code,” were inferred, among which “Dijkstra” was found to be the primary interest. During one hours from 11:00, a total of two interests, i.e., “tteokbokki” and “well-known restaurant,” were inferred, among which “tteokbokki” was found to be a higher-priority interest. During one hour from 12:00, no interests were inferred. During one hour from 13:00, a total of three interests, i.e., “tumbler,” “blue bottle,” and “Dijkstra,” were inferred, among which “blue bottle” was found to be the primary interest. The user device 100 may provide the user with the interest chart as shown in FIG. 16, and when the user selects a particular interest from the interest chart, the user device 100 may execute an application related to the interest, and at a corresponding time point, may display, on a screen, content related to a user interaction on the user device 100. Via the interest chart as shown in FIG. 16, not only the user's interests but also the user's activity information for a corresponding time span may be inferred, the user's current location or destination may be inferred, and activity information expected at a subsequent time may also be inferred.

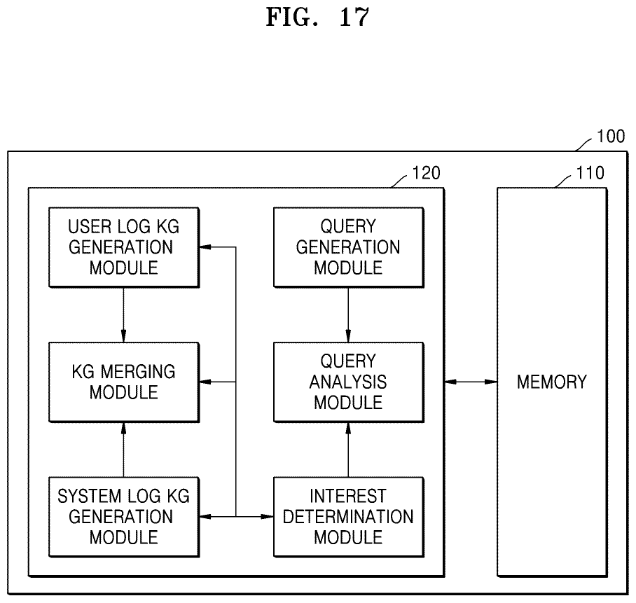

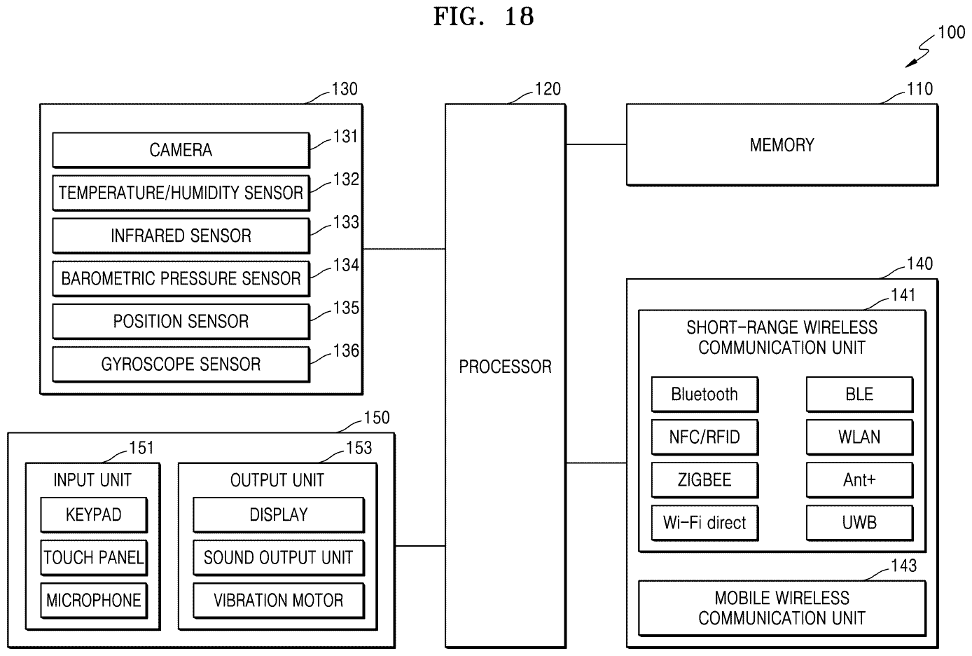

FIG. 17 is a block diagram for describing an operation of a processor of the user device 100, according to an embodiment of the disclosure. FIG. 18 is a block diagram for describing a configuration and operations of the user device 100, according to an embodiment of the disclosure.

Referring to FIG. 17, the user device 100 according to an embodiment of the disclosure may include memory 110 and a processor 120, but the disclosure is not limited thereto, and a general-purpose configuration may be further added. For example, as shown in FIG. 18, the user device 100 may further include a sensing unit 130, a communication unit 140, an input/output unit 150, in addition to the memory 110 and the processor 120. Hereinafter, referring to FIGS. 17 and 18, the respective components will be described in detail with reference to FIGS. 17 and 18.

The memory 110 according to an embodiment of the disclosure may store a program for processing and control by the processor 120 and may store data and information input to or generated from the user device 100. The memory 110 may store instructions, a data structure, and program code which are readable by the processor 120. Operations performed by the processor 120 may be implemented by executing instructions or program code stored in the memory 110.

The memory 110 according to an embodiment of the disclosure may include a flash memory-type memory, a hard disk-type memory, a multimedia card micro-type memory, or a card-type memory (for example, SD or XD memory), may include non-volatile memory including at least one of read-only memory (ROM), electrically erasable programmable ROM (EEPROM), programmable ROM (PROM), magnetic memory, a magnetic disc, or an optical disc, and may include volatile memory such as random access memory (RAM) or static RAM (SRAM).

The memory 110 according to an embodiment of the disclosure may store one or more instructions and/or programs that control the user device 100 to train or use a neural network model.

The processor 120 according to an embodiment of the disclosure may execute instructions or programmed software modules stored in the memory 110 so as to control operations or functions so that the user device 100 may perform tasks. The processor 120 may include hardware components that perform arithmetic, logic, and input/output calculations and signal processing. The processor 120 may execute one or more instructions stored in the memory 110 so as to control all operations of the user device 100. The processor 120 may execute programs stored in the memory 110 so as to control the sensing unit 130 including at least one sensor, the communication unit 140, and the input/output unit 150.

The processor 120 may include various types of processing circuitry and/or a plurality of processors. For example, the term “processor” as used herein, including the claims, may include various types of processing circuitry including at least one processor. “At least one processor” may be configured to individually and/or collectively perform various functions described herein. As used herein, the “processor,” “at least one processor,” and “one or more processors” may be configured to perform various functions. However, these terms cover, without limitation, a situation where one processor performs some functions while other processor(s) perform other functions, and a situation where a single processor may perform all the functions. In addition, the “at least one processor” may include a combination of processors that perform the disclosed various functions in a distributed manner. The “at least one processor” may execute program instructions to accomplish or perform various functions.

The processor 120 according to an embodiment of the disclosure may include, for example, at least one of a CPU, a microprocessor, a GPU, application specific integrated circuits (ASICs), DSPs, digital signal processing devices (DSPDs), programmable logic devices (PLDs), field programmable gate arrays (FPGAs), an AP, an NPU, or a dedicated AI processor designed with a hardware structure specialized for processing an AI model, but the disclosure is not limited thereto. Each processor constituting the processor 120 may be a dedicated processor for performing a preset function.

The AI processor according to an embodiment of the disclosure may use an AI model to perform calculation and control to process a task set to be performed by the user device 100. The AI processor may be manufactured in the form of a dedicated hardware chip for AI, or may be manufactured as part of a general-purpose processor (for example, a CPU or an AP) or part of a graphics-dedicated processor (for example, a GPU) and mounted on the user device 100.

The sensing unit 130 according to an embodiment of the disclosure may include a plurality of sensors configured to detect information about surrounding environment of the user device 100. For example, the sensing unit 130 may include a camera 131, a temperature/humidity sensor 132, an infrared sensor 133, a barometric pressure sensor 134, a position sensor 135, a gyroscope sensor 136, or the like, but the disclosure is not limited thereto. Because the functions of the sensors may be intuitively inferred from the names of the sensors by one of ordinary skill in the art, the functions of the sensors are briefly described below.

The camera 131 according to an embodiment of the disclosure may include a stereo camera, a mono camera, a wide-angle camera, an around-view camera, or a three-dimensional (3D) vision sensor. The temperature/humidity sensor 132 may measure a temperature or humidity of a position where the user device 100 is positioned. The infrared sensor 133 may be an active infrared sensor that detects a change by radiating infrared light and blocking the light, or a passive infrared sensor that does not have a light emitter and only detects a change in infrared light received from the outside. The barometric pressure sensor 134 may measure a barometric pressure at a position where the user device 100 is positioned. The position sensor 135 may detect a position of the user device 100. For example, the position sensor 135 may be a GPS. The gyroscope sensor 136 may detect angular velocity. The gyroscope sensor 136 may be used to measure the position of the user device 100 and to set the moving direction of the user device 100.

The communication unit 140 may include one or more components that enable the user device 100 to communicate with an external device, for example, a server or other electronic devices. For example, the communication unit 140 may include a short-range wireless communication unit 141, a mobile wireless communication unit 143, or the like, but the disclosure is not limited thereto.

The short-range wireless communication unit 141 may include a Bluetooth communication unit, a Bluetooth Low Energy (BLE) communication unit, a Near Field Communication (NFC) communication unit, a wireless local area network (WLAN) (Wi-Fi) communication unit, a ZigBee communication unit, an Ant+ communication unit, a Wi-Fi Direct (WFD) communication unit, an Ultra-Wideband (UWB) communication unit, an Infrared Data Association (IrDA) communication unit, a micro wave (uWave) communication unit, or the like, but the disclosure is not limited thereto.

The mobile wireless communication unit 143 may transmit and receive radio signals to and from at least one of a base station, an external terminal, or a server on a mobile communication network. The radio signals may include voice call signals, video call signals, or various types of data according to text/multimedia message transmission and reception.

The input/output unit 150 may include an input unit 151 and an output unit 153. In the input/output unit 150, the input unit 151 and the output unit 153 may be provided in a separate form, or may be provided in an integrated form such as a touch screen. The input/output unit 150 may receive input information from the user, and may provide output information to the user.

The input unit 151 may refer to a device or component for obtaining the user input for controlling the user device 100. For example, the input unit 151 may include a key pad, a touch panel (a contact capacitance type touch panel, a pressure resistance film type touch panel, an infrared detection type touch panel, a surface ultrasonic conduction type touch panel, an integral tension measurement type touch panel, a piezo effect type touch panel, etc.), or a microphone. In addition, the input unit 151 may include a gaze tracking sensor, a jog wheel, a jog switch, or the like, but the disclosure is not limited thereto, and an arbitrary sensor of the sensing unit 130 may be used to detect the user input. The user input may be in the form of a text, a voice, or a gesture, but the disclosure is not limited thereto. The user may input a search word or a sentence-form search command via a user interface or a microphone of the user device 100. The user may provide the user input to the user device 100 via a predefined gesture or behavior (for example, an action of shaking the user device 100).

The output unit 153 may output an audio signal, a video signal, or a vibration signal, and the output unit 153 may include a display, a sound output unit, and a vibration motor. The display may display information processed by the user device 100. For example, the display may display the user interface for receiving a user's manipulation. When the display and a touch pad are configured as a touch screen having a layer structure, the display may be used as an input device as well as an output device. The display may include at least one of a liquid crystal display, a thin-film transistor-liquid crystal display, an organic light-emitting diode, a flexible display, or a 3D display. According to the implementation mode of the user device 100, the user device 100 may include two or more displays. The sound output unit may output audio data stored in the memory 110. The sound output unit may output sound signals related to the functions performed by the user device 100. The sound output interface may include a speaker, a buzzer, or the like.

The user device 100 according to an embodiment of the disclosure may include the memory 110 including one or more storage media storing instructions, and the at least one processor 120 including processing circuitry. Referring to FIG. 17, the at least one processor 120 may execute instructions to operate a query generation module 121, a query analysis module 122, an interest determination module 123, the system log knowledge graph generation module 124, the user log knowledge graph generation module 125, and a knowledge graph merging module 126. The instructions, when executed by the at least one processor 120, may cause the user device 100 to generate personal knowledge graphs based on system log data or user log data, for example, a system log knowledge graph, a user log knowledge graph, and an interest knowledge graph. The instructions, when executed by the at least one processor 120, may cause the user device 100 to infer a user's interest based on the system log knowledge graph and the user log knowledge graph.

According to an embodiment of the disclosure, one or more instructions, when executed by the at least one processor 120, may cause the user device 100 to generate a query when there is a request from the user or an interaction between the user device 100 and the user. The user device 100 may execute the query generation module 121 to generate a query, based on at least one of the type of service provided by the user device 100, a user input, or the user's state or situation.

The query requesting the user's interest may be generated in a form based on the type of service. For example, in the case of over-the-top (OTT) media service, the query may request the interest derived from videos in a viewing history such as genres or providers of videos viewed by the user. The query requesting the user's interest may be generated in a form based on the user input. For example, the query may request the interest based on interest categories or interest keywords defined or registered by the user. The query requesting the user's interest may be generated in a form based on the user's state or situation. For example, the query may request the interest related to a particular time span during which the user was busy with work, a time when the user engaged in a particular activity, or a time when a change in the user's state occurred.

According to an embodiment of the disclosure, one or more instructions, when executed by the at least one processor 120, may cause the user device 100 to analyze the query and obtain time span information for determining the user's interest. The user device 100 may execute the query analysis module 122 to determine a time span during which information about the user's interest is required. The query analysis module 122 may analyze a query when the query is input from the query generation module 121, and may obtain time span information for determining the user's interest and query elements such as keywords, categories, the user's situation, etc.

According to an embodiment of the disclosure, one or more instructions, when executed by the at least one processor 120, may cause the user device 100 to retrieve a personal knowledge graph necessary for determining the user's interest. The user device 100 may execute the interest determination module 123 to obtain at least one personal knowledge graph, according to the content of the query analyzed by the query analysis module 122.

The interest determination module 123 may obtain at least one system log knowledge graph from the system log knowledge graph generation module 124, the at least one system log knowledge graph corresponding to the time span information for determining the user's interest. The interest determination module 123 may obtain at least one user log knowledge graph from the user log knowledge graph generation module 125, the at least one user log knowledge graph corresponding to the time span information for determining the user's interest. The interest determination module 123 may obtain at least one interest knowledge graph from the knowledge graph merging module 126, the at least one interest knowledge graph corresponding to the time span information for determining the user's interest. The knowledge graph merging module 126 may obtain a system log knowledge graph from the system log knowledge graph generation module 124, and may obtain a user log knowledge graph from the user log knowledge graph generation module 125. The knowledge graph merging module 126 may generate an interest knowledge graph by merging a system log knowledge graph and a user log knowledge graph corresponding to the same time span information, based on nodes that corresponds to each other in the two graphs.

The knowledge graph merging module 126 may obtain an interest knowledge graph by merging, based on application information, which is semantic index information corresponding to sub-time span information of the lowermost layer of a preset unit time, and the sub-time span information of the lowermost layer of the preset unit time, a system log knowledge graph, which includes the sub-time span information of the lowermost layer of the preset unit time as a root node, and a user log knowledge graph, which includes a contact node having the same application information as the application information which is the semantic index information. The knowledge graph merging module 126 may generate a node representing inferred activity information as the user's state within the preset unit time, based on nodes of a result obtained by merging the system log knowledge graph and the user log knowledge graph, and may add the node to the interest knowledge graph.

According to an embodiment of the disclosure, one or more instructions, when executed by the at least one processor 120, may cause the user device 100 to obtain user interaction-based semantic index information from at least one system log knowledge graph. The user device 100 may execute the interest determination module 123 to obtain the semantic index information, based on at least one node corresponding to at least one system monitoring criterion, from the at least one system log knowledge graph.

The interest determination module 123 may obtain system monitoring criteria used to determine the user's interest from the at least one system log knowledge graph, according to a preset rule. The interest determination module 123 may obtain the semantic index information from the at least one system log knowledge graph, based on at least one node corresponding to the system monitoring criteria obtained according to the preset rule.

The interest determination module 123 may obtain at least one system monitoring criterion used to determine the user's interest, according to the content of the query, by using a system monitoring criterion selection model trained based on past history information used to determine the semantic index information. The interest determination module 123 may obtain the semantic index information from the at least one system log knowledge graph, based on at least one node corresponding to the at least one system monitoring criterion obtained by using the system monitoring criterion selection model.

When the time span information for determining the user's interest includes a combination of a plurality of pieces of sub-time span information of a predefined time range, the interest determination module 123 may obtain semantic index information from a system log knowledge graph corresponding to each sub-time span information. The interest determination module 123 may search for at least one node corresponding to at least one system monitoring criterion used to determine the interest, in a system log knowledge graph corresponding to sub-time span information. The interest determination module 123 may determine semantic index information, based on the at least one node searched for in the system log knowledge graph corresponding to the sub-time span information.

The system log knowledge graph corresponding to the sub-time span information may be a generated hierarchical structure by setting upper-level sub-time span information, which has a time range equal to the sum of time spans of lower-level sub-time span information, as a root node and setting results of integrating system log data collected within a time span based on the lower-level sub-time span information, and of aggregating, per system monitoring criterion, the system log data, as respective nodes connected to the root node of the upper-level sub-time span information, and by connecting the root node of the upper-level sub-time span information to root nodes of the lower-level sub-time span information. When the system log knowledge graph corresponding to the sub-time span information is a hierarchical structure, the interest determination module 123 may obtain semantic index information from a system log knowledge graph corresponding to lower-level sub-time span information, based on at least one system monitoring criterion and semantic index information, which are used to determine the interest in a system log knowledge graph corresponding to upper-level sub-time span information, from the uppermost layer to the lowermost layer. The interest determination module 123 may determine a similarity between the semantic index information obtained from the system log knowledge graph corresponding to the lower-level sub-time span information and the semantic index information obtained from the system log knowledge graph corresponding to the upper-level sub-time span information. The interest determination module 123 may treat the semantic index information, obtained from the system log knowledge graph corresponding to the lower-level sub-time span information, as valid when the similarity satisfies a preset criterion. The interest determination module 123 may treat the semantic index information corresponding to the lower-level sub-time span information as invalid when the similarity does not satisfy the preset criterion, and may stop searching into a lower layer of a system log knowledge graph.

According to an embodiment of the disclosure, one or more instructions, when executed by at least one processor 120, may cause the user device 100 to search for at least one contact node, based on the semantic index information obtained from the at least one system log knowledge graph, in at least one user log knowledge graph. The user device 100 may execute the interest determination module 123 to search for a contact node having the same information as the semantic index information, in the at least one user log knowledge graph.

When the time span information for determining the user's interest includes a combination of a plurality of pieces of sub-time span information of a predefined time range, the interest determination module 123 may search for, in at least one user log knowledge graph corresponding to sub-time span information, at least one contact node, based on semantic index information corresponding to the sub-time span information. When a system log knowledge graph corresponding to sub-time span information is a hierarchical structure, the interest determination module 123 may search for at least one contact node, based on semantic index information corresponding to sub-time span information of the lowermost layer of a preset unit time, in at least one user log knowledge graph generated for each preset unit time.

According to an embodiment of the disclosure, one or more instructions, when executed by the at least one processor 120, may cause the user device 100 to obtain the user's interest corresponding to the time span information for determining the user's interest, based on at least one node that satisfies a preset condition, from a user log knowledge graph including the at least one contact node. The user device 100 may execute the interest determination module 123 to obtain the user's interest from at least one user log knowledge graph, based on how long and how frequently an entity related to the user's activity information performed on the user device 100 appears within a time span based on the time span information for determining the user's interest.

The interest determination module 123 may obtain an entity of the at least one node as the user's interest from the at least one user log knowledge graph by applying, to each node, a weight based on a validity within a time span based on the time span information for determining the user's interest and a relevance to other nodes. The validity of a node within the time span based on the time span information for determining the user's interest refers to a time span during which the node is valid as the interest, within the entire time span. The relevance of each node to other nodes in a user log knowledge graph refers to the extent to which a corresponding node influences other nodes or how closely it is related to them. When the interest determination module 123 obtains the interest knowledge graph from the knowledge graph merging module 126, the interest determination module 123 may obtain the user's interest from the interest knowledge graph, based on the at least one node that satisfies the preset condition.

An embodiment of the disclosure may be implemented in the form of a recording medium including computer-executable instructions such as program modules executable by a computer. A computer-readable recording medium may be any available media that are accessible by the computer and may include any volatile and non-volatile media and any removable and non-removable media. In addition, the computer-readable recording medium may include a computer storage medium and a communication medium. The computer storage medium may include any volatile, non-volatile, removable, and non-removable media that are implemented in any method or technology for storage of information such as computer-readable instructions, data structures, program modules, or other data. The communication medium may typically include computer-readable instructions, data structures, or other data of a modulated data signal, such as program modules.

Also, the computer-readable recording medium may be provided in the form of a non-transitory storage medium. The “non-transitory storage medium” is a tangible device and only means not including a signal (for example, electromagnetic waves). This term does not distinguish between a case where data is semi-permanently stored in a storage medium and a case where data is temporarily stored in a storage medium. For example, the “non-transitory storage medium” may include a buffer in which data is temporarily stored.

The method according to an embodiment of the disclosure may be provided by being included in a computer program product. The computer program product may be traded as merchandise between a seller and a purchaser. The computer program product may be distributed in the form of a machine-readable storage medium (for example, compact disc ROM (CD-ROM)), or may be distributed (for example, downloaded or uploaded) online either via an application store or directly between two user devices (for example, smartphones). In the case of the online distribution, at least a part of a computer program product (for example, downloadable app) is stored at least temporarily on a machine-readable storage medium, such as a server of a manufacturer, a server of an application store, or memory of a relay server, or may be temporarily generated.

According to an embodiment of the disclosure, a computer-readable recording medium having recorded thereon a program for executing a method of generating a personal knowledge graph (for example, a system log knowledge graph, a user log knowledge graph, and an interest knowledge graph) based on system log data or user log data, or executing a method of inferring a user's interest, is provided.

According to an embodiment of the disclosure, a method of inferring a user's interest is provided. The method of inferring the user's interest may include obtaining time span information for determining the user's interest from a query (S1010). In addition, the method of inferring the user's interest may include obtaining user interaction-based semantic index information from at least one system log knowledge graph in which results of aggregating, per system monitoring criterion, system log data are set as respective nodes, the at least one system log knowledge graph corresponding to the time span information for determining the user's interest (S1020). In addition, the method of inferring the user's interest may include searching for at least one contact node, based on the user interaction-based semantic index information, in at least one user log knowledge graph in which entities related to the user's activity information based on user log data are set as respective nodes and in which a relationship between the entities is represented, the at least one user log knowledge graph corresponding to the time span information for determining the user's interest (S1030). In addition, the method of inferring the user's interest may include obtaining the user's interest corresponding to the time span information for determining the user's interest, based on at least one node that satisfies a preset condition in a user log knowledge graph including the at least one contact node (S1040).

In addition, according to an embodiment of the disclosure, the obtaining of the user interaction-based semantic index information (S1020) may include obtaining the semantic index information from the at least one system log knowledge graph, based on at least one node corresponding to at least one system monitoring criterion used to determine the user's interest, according to a preset rule.

In addition, according to an embodiment of the disclosure, the obtaining of the user interaction-based semantic index information (S1020) may include obtaining the user interaction-based semantic index information, based on at least one node corresponding to at least one system monitoring criterion used to determine the user's interest, according to content of the query, by using a system monitoring criterion selection model trained based on past history information used to obtain the semantic index information.

In addition, according to an embodiment of the disclosure, the obtaining of the user interaction-based semantic index information (S1020) may include, when the time span information for determining the user's interest includes a combination of a plurality of pieces of sub-time span information of a predefined time range, searching for at least one node corresponding to at least one system monitoring criterion used to determine the user's interest, in a system log knowledge graph in which sub-time span information is set as a root node and in which results of aggregating, per system monitoring criterion, system log data collected within a time span based on the sub-time span information are set as respective nodes connected to the root node, the system log knowledge graph corresponding to sub-time span information. In addition, the obtaining of the user interaction-based semantic index information (S1020) may include determining semantic index information corresponding to the sub-time span information, based on the searched at least one node. In addition, the searching for the at least one contact node (S1030) may include searching for the at least one contact node, based on the user interaction-based semantic index information corresponding to the sub-time span information, in the at least one user log knowledge graph.

In addition, according to an embodiment of the disclosure, the system log knowledge graph corresponding to the sub-time span information may be a generated hierarchical structure by setting upper-level sub-time span information, which has a time range equal to the sum of time spans of lower-level sub-time span information, as a root node and setting results of integrating system log data collected within a time span based on the lower-level sub-time span information, and of aggregating, per system monitoring criterion, the system log data, as respective nodes connected to the root node of the upper-level sub-time span information, and by connecting the root node of the upper-level sub-time span information to root nodes of the lower-level sub-time span information.

In addition, according to an embodiment of the disclosure, the obtaining of the user interaction-based semantic index information (S1020) may include obtaining user interaction-based semantic index information from a system log knowledge graph corresponding to lower-level sub-time span information, based on at least one system monitoring criterion and user interaction-based semantic index information, which are used to determine the user's interest in a system log knowledge graph corresponding to upper-level sub-time span information, from the uppermost layer to the lowermost layer of the system log knowledge graph corresponding to the sub-time span information, which is the hierarchical structure. In addition, the searching for the at least one contact node (S1030) may include searching for, in the at least one user log knowledge graph generated for each preset unit time, the at least one contact node, based on the user interaction-based semantic index information corresponding to sub-time span information of the lowermost layer of a preset unit time.

In addition, according to an embodiment of the disclosure, the method of inferring the user's interest may further include obtaining an interest knowledge graph by merging, based on application information, which is the user interaction-based semantic index information corresponding to the sub-time span information of the lowermost layer of the preset unit time, and the sub-time span information of the lowermost layer of the preset unit time, a system log knowledge graph, which includes the sub-time span information of the lowermost layer of the preset unit time as a root node, and a user log knowledge graph, which includes the contact node having the same application information as the application information which is the user interaction-based semantic index information. In addition, the obtaining of the user's interest (S1040) may include obtaining the user's interest from the interest knowledge graph, based on the at least one node that satisfies the preset condition.

In addition, according to an embodiment of the disclosure, the interest knowledge graph may further include a node representing inferred activity information as the user's state within the preset unit time, based on nodes of a result obtained by merging the system log knowledge graph and the user log knowledge graph.

In addition, according to an embodiment of the disclosure, the obtaining of the user's interest (S1040) may include obtaining an entity of the at least one node as the user's interest from the at least one user log knowledge graph by applying, to each node, a weight based on a validity within a time span based on the time span information for determining the user's interest and a relevance to other nodes.

According to an embodiment of the disclosure, a computer-readable recording medium having recorded thereon a program for executing the method of inferring the user's interest is provided.

According to an embodiment of the disclosure, the user device 100 that infers a user's interest is provided. The user device 100 may include: the memory 110 including one or more storage mediums storing instructions; and at least one processor 120 including processing circuitry. One or more instructions, when executed by the at least one processor 120, may cause the user device 100 to obtain time span information for determining the user's interest from a query. In addition, the one or more instructions, when executed by the at least one processor 120, may cause the user device 100 to obtain user interaction-based semantic index information from at least one system log knowledge graph in which results of aggregating, per system monitoring criterion, system log data are set as respective nodes, the at least one system log knowledge graph corresponding to the time span information for determining the user's interest. In addition, the one or more instructions, when executed by the at least one processor 120, may cause the user device 100 to search for at least one contact node, based on the user interaction-based semantic index information, in at least one user log knowledge graph in which entities related to the user's activity information based on user log data are set as respective nodes and in which a relationship between the entities is represented, the at least one user log knowledge graph corresponding to the time span information for determining the user's interest. In addition, the one or more instructions, when executed by the at least one processor 120, may cause the user device 100 to obtain the user's interest corresponding to the time span information for determining the user's interest, based on at least one node that satisfies a preset condition, from a user log knowledge graph including the at least one contact node.

In addition, according to an embodiment of the disclosure, the one or more instructions, when executed by the at least one processor 120, may cause the user device 100 to obtain the semantic index information from the at least one system log knowledge graph, based on at least one node corresponding to at least one system monitoring criterion used to determine the user's interest, according to a preset rule.

In addition, according to an embodiment of the disclosure, the one or more instructions, when executed by the at least one processor 120, may cause the user device 100 to obtain the user interaction-based semantic index information, based on at least one node corresponding to at least one system monitoring criterion used to determine the user's interest, according to content of the query, by using a system monitoring criterion selection model trained based on past history information used to obtain the user interaction-based semantic index information.

In addition, according to an embodiment of the disclosure, the one or more instructions, when executed by the at least one processor 120, may cause the user device 100 to, when the time span information for determining the user's interest includes a combination of a plurality of pieces of sub-time span information of a predefined time range, search for at least one node corresponding to at least one system monitoring criterion used to determine the user's interest, in a system log knowledge graph in which sub-time span information is set as a root node and in which results of aggregating, per system monitoring criterion, system log data collected within a time span based on the sub-time span information are set as respective nodes connected to the root node, the system log knowledge graph corresponding to sub-time span information, and determine semantic index information corresponding to the sub-time span information, based on the searched at least one node. In addition, the one or more instructions, when executed by the at least one processor 120, may cause the user device 100 to search for the at least one contact node, based on the user interaction-based semantic index information corresponding to the sub-time span information, in the at least one user log knowledge graph.

In addition, according to an embodiment of the disclosure, the system log knowledge graph corresponding to the sub-time span information may be a generated hierarchical structure by setting upper-level sub-time span information, which has a time range equal to the sum of time spans of lower-level sub-time span information, as a root node and setting results of integrating system log data collected within a time span based on the lower-level sub-time span information, and of aggregating, per system monitoring criterion, the system log data, as respective nodes connected to the root node of the upper-level sub-time span information, and by connecting the root node of the upper-level sub-time span information to root nodes of the lower-level sub-time span information.

In addition, according to an embodiment of the disclosure, the one or more instructions, when executed by the at least one processor 120, may cause the user device 100 to obtain user interaction-based semantic index information from a system log knowledge graph corresponding to lower-level sub-time span information, based on at least one system monitoring criterion and user interaction-based semantic index information, which are used to determine the user's interest in a system log knowledge graph corresponding to upper-level sub-time span information, from the uppermost layer to the lowermost layer of the system log knowledge graph corresponding to the sub-time span information, which is the hierarchical structure. In addition, the one or more instructions, when executed by the at least one processor 120, may cause the user device 100 to search for, in the at least one user log knowledge graph generated for each preset unit time, at least one contact node, based on user interaction-based semantic index information corresponding to sub-time span information of the lowermost layer of a preset unit time.

In addition, according to an embodiment of the disclosure, the one or more instructions, when executed by the at least one processor 120, may cause the user device 100 to determine a similarity between the semantic index information obtained from the system log knowledge graph corresponding to the lower-level sub-time span information and the semantic index information obtained from the system log knowledge graph corresponding to the upper-level sub-time span information. In addition, the one or more instructions, when executed by the at least one processor 120, may cause the user device 100 to, when the similarity satisfies a preset criterion, treat the semantic index information obtained from the system log knowledge graph corresponding to the lower-level sub-time span information as valid, and when the similarity does not satisfy the preset criterion, treat the semantic index information corresponding to the lower-level sub-time span information as invalid and stop searching into a lower layer of a system log knowledge graph.

In addition, according to an embodiment of the disclosure, the one or more instructions, when executed by the at least one processor 120, may cause the user device 100 to obtain an interest knowledge graph by merging, based on application information, which is the user interaction-based semantic index information corresponding to the sub-time span information of the lowermost layer of the preset unit time, and the sub-time span information of the lowermost layer of the preset unit time, a system log knowledge graph, which includes the sub-time span information of the lowermost layer of the preset unit time as a root node, and a user log knowledge graph, which includes the contact node having the same application information as the application information which is the user interaction-based semantic index information. In addition, the one or more instructions, when executed by the at least one processor 120, may cause the user device 100 to obtain the user's interest from the interest knowledge graph, based on the at least one node that satisfies the preset condition.

In addition, according to an embodiment of the disclosure, the one or more instructions, when executed by the at least one processor 120, may cause the user device 100 to generate a node representing inferred activity information as the user's state within the preset unit time, based on nodes of a result obtained by merging the system log knowledge graph and the user log knowledge graph, and add the node to the interest knowledge graph.

In addition, according to an embodiment of the disclosure, the one or more instructions, when executed by the at least one processor 120, may cause the user device 100 to obtain an entity of the at least one node as the user's interest from the at least one user log knowledge graph by applying, to each node, a weight based on a validity within a time span based on the time span information for determining the user's interest and a relevance to other nodes.

It will be understood by those of ordinary skill in the art that the embodiments of the disclosure are provided for illustration and may be implemented in different ways without departing from the spirit and scope of the disclosure. Therefore, it should be understood that the foregoing embodiments of the disclosure are provided for illustrative purposes only and are not to be construed in any way as limiting the disclosure. For example, each component described as a single type may be implemented in a distributed manner, and likewise, components described as being distributed may be implemented as a combined type.

The scope of the disclosure should be defined by the appended claims and equivalents thereof, and any changes or modifications derived from the appended claims and equivalents thereof should be construed as falling within the scope of the disclosure.

What is claimed is:

1. A method of inferring an interest associated with a user, the method being performed by at least one processor, the method comprising:
obtaining time span information for determining the interest associated with the user from a query;
obtaining user interaction-based semantic index information from at least one system log knowledge graph, the at least one system log knowledge graph corresponding to the time span information, wherein each system log knowledge graph comprises, as respective nodes, results of aggregating system log data according to system monitoring criteria;
searching for at least one contact node, based on the user interaction-based semantic index information, in at least one user log knowledge graph, the at least one user log knowledge graph corresponding to the time span information, wherein each of the at least one user log knowledge graph comprises, as respective nodes, entities related to activity information associated with the user based on user log data and comprises representations of relationships between the entities; and
obtaining the interest associated with the user corresponding to the time span information, based on at least one node that satisfies a preset condition, from a user log knowledge graph comprising the at least one contact node.

2. The method of claim 1, wherein the obtaining the user interaction-based semantic index information comprises obtaining the user interaction-based semantic index information from the at least one system log knowledge graph, based on at least one node corresponding to at least one system monitoring criterion used to determine the interest, according to a preset rule.

3. The method of claim 1, wherein the obtaining the user interaction-based semantic index information comprises obtaining, using a system monitoring criterion selection model trained based on past history information, the user interaction-based semantic index information based on at least one node corresponding to at least one system monitoring criterion used to determine the interest, according to a content of the query.

4. The method of claim 1, wherein the obtaining the user interaction-based semantic index information comprises:
based on the time span information comprising a combination of a plurality of pieces of sub-time span information of a predefined time range, determining at least one node corresponding to at least one system monitoring criterion used to determine the interest, in a system log knowledge graph, wherein the system log knowledge graph has a sub-time span information set as a root node and results of aggregating, per system monitoring criterion, system log data collected within a time span based on the sub-time span information are set as respective nodes connected to the root node, and wherein the system log knowledge graph corresponds to sub-time span information, and
determining user interaction-based semantic index information corresponding to the sub-time span information, based on the at least one node corresponding to the at least one system monitoring criterion, and
wherein the searching for the at least one contact node comprises searching for the at least one contact node, based on the user interaction-based semantic index information corresponding to the sub-time span information, in the at least one user log knowledge graph.

5. The method of claim 4, wherein the system log knowledge graph corresponding to the sub-time span information is a generated hierarchical structure generated by:
setting, as the root node, upper-level sub-time span information, the upper-level sub-time span information having a time range equal to a sum of time spans of lower-level sub-time span information,
setting, as respective nodes connected to the root node of the upper-level sub-time span information, results of integrating system log data collected within the time span based on the lower-level sub-time span information, and results of aggregating, per system monitoring criterion, the system log data, and
connecting the root node of the upper-level sub-time span information to root nodes of the lower-level sub-time span information.

6. The method of claim 5, wherein the obtaining the user interaction-based semantic index information comprises:
obtaining the user interaction-based semantic index information from a system log knowledge graph corresponding to lower-level sub-time span information, based on at least one system monitoring criterion and semantic index information, which are used to determine the interest in a system log knowledge graph corresponding to upper-level sub-time span information, from an uppermost layer to a lowermost layer of the system log knowledge graph corresponding to the sub-time span information, and
wherein the searching for the at least one contact node comprises searching for, in the at least one user log knowledge graph generated for each preset unit time, the at least one contact node, based on semantic index information corresponding to sub-time span information of a lowermost layer of a preset unit time.

7. The method of claim 6, further comprising obtaining an interest knowledge graph by merging, based on application information and the sub-time span information of the lowermost layer of the preset unit time, the system log knowledge graph and the user log knowledge graph,
wherein the application information is the semantic index information corresponding to the sub-time span information of the lowermost layer of the preset unit time,
wherein the system log knowledge graph comprises the sub-time span information of the lowermost layer of the preset unit time as the root node, and the user log knowledge graph comprises a contact node having application information that is the same as the application information, and
wherein the obtaining the interest comprises obtaining the interest from the interest knowledge graph, based on the at least one node that satisfies the preset condition.

8. The method of claim 7, wherein the interest knowledge graph further comprises a node representing inferred activity information as a state of the user within the preset unit time, based on nodes of a result obtained by merging the system log knowledge graph and the user log knowledge graph.

9. The method of claim 1, wherein the obtaining the interest comprises obtaining an entity of the at least one node as the interest from the at least one user log knowledge graph by applying, to each node, a weight based on a validity within a time span based on the time span information for determining the interest and a relevance to other nodes.

10. A non-transitory computer-readable recording medium storing instructions, the instructions when executed by at least one processor of an electronic device, collectively or individually, cause the electronic device to:
obtain time span information for determining the interest associated with a user from a query;
obtain user interaction-based semantic index information from at least one system log knowledge graph, the at least one system log knowledge graph corresponding to the time span information, wherein each system log knowledge graph comprises, as respective nodes, results of aggregating system log data according to system monitoring criteria;
search for at least one contact node, based on the user interaction-based semantic index information, in at least one user log knowledge graph, the at least one user log knowledge graph corresponding to the time span information, wherein each of the at least one user log knowledge graph comprises, as respective nodes, entities related to activity information associated with the user based on user log data and comprises representations of relationships between the entities; and
obtain an interest associated with the user corresponding to the time span information, based on at least one node that satisfies a preset condition, from a user log knowledge graph comprising the at least one contact node.

11. A user device that infers an interest associated with a user, the user device comprising:
memory including one or more storage mediums storing instructions; and
at least one processor including processing circuitry,
wherein one or more instructions, when executed by the at least one processor individually or collectively, cause the user device to:
obtain time span information for determining the interest associated with a user from a query;
obtain user interaction-based semantic index information from at least one system log knowledge graph, the at least one system log knowledge graph corresponding to the time span information, wherein each system log knowledge graph comprises, as respective nodes, results of aggregating system log data according to system monitoring criteria;
search for at least one contact node, based on the user interaction-based semantic index information, in at least one user log knowledge graph, the at least one user log knowledge graph corresponding to the time span information, wherein each of the at least one user log knowledge graph comprises, as respective nodes, entities related to activity information associated with the user based on user log data and comprises representations of relationships between the entities; and
obtain the interest associated with the user corresponding to the time span information, based on at least one node that satisfies a preset condition, from a user log knowledge graph comprising the at least one contact node.

12. The user device of claim 11, wherein the one or more instructions, when executed by the at least one processor individually or collectively, further cause the user device to obtain the user interaction-based semantic index information from the at least one system log knowledge graph, based on at least one node corresponding to at least one system monitoring criterion used to determine the interest, according to a preset rule.

13. The user device of claim 11, wherein the one or more instructions, when executed by the at least one processor individually or collectively, further cause the user device to obtain, using a system monitoring criterion selection model trained based on past history information, the user interaction-based semantic index information based on at least one node corresponding to at least one system monitoring criterion used to determine the interest, according to a content of the query.

14. The user device of claim 11, wherein the one or more instructions, when executed by the at least one processor individually or collectively, further cause the user device to:
based on the time span information comprising a combination of a plurality of pieces of sub-time span information of a predefined time range, determine at least one node corresponding to at least one system monitoring criterion used to determine the interest, in a system log knowledge graph, wherein the system log knowledge graph has a sub-time span information is set as a root node and results of aggregating, per system monitoring criterion, system log data collected within a time span based on the sub-time span information are set as respective nodes connected to the root node, and wherein the system log knowledge graph corresponds to sub-time span information, and
determine user interaction-based semantic index information corresponding to the sub-time span information, based on the at least one node corresponding to the at least one system monitoring criterion; and
search for the at least one contact node, based on the user interaction-based semantic index information corresponding to the sub-time span information, in the at least one user log knowledge graph.

15. The user device of claim 14, wherein the system log knowledge graph corresponding to the sub-time span information is a generated hierarchical structure generated by:
setting, as the root node, upper-level sub-time span information, the upper-level sub-time span information having a time range equal to a sum of time spans of lower-level sub-time span information,
setting, as respective nodes connected to the root node of the upper-level sub-time span information, results of integrating system log data collected within the time span based on the lower-level sub-time span information, and results of aggregating, per system monitoring criterion, the system log data, and
connecting the root node of the upper-level sub-time span information to root nodes of the lower-level sub-time span information.

16. The user device of claim 15, wherein the one or more instructions, when executed by the at least one processor individually or collectively, further cause the user device to:
obtain the user interaction-based semantic index information from a system log knowledge graph corresponding to lower-level sub-time span information, based on at least one system monitoring criterion and semantic index information, which are used to determine the interest in a system log knowledge graph corresponding to upper-level sub-time span information, from an uppermost layer to a lowermost layer of the system log knowledge graph corresponding to the sub-time span information; and
search for, in the at least one user log knowledge graph generated for each preset unit time, the at least one contact node, based on semantic index information corresponding to sub-time span information of a lowermost layer of a preset unit time.

17. The user device of claim 16, wherein the one or more instructions, when executed by the at least one processor individually or collectively, further cause the user device to:
determine a similarity between the user interaction-based semantic index information obtained from the system log knowledge graph corresponding to the lower-level sub-time span information and the user interaction-based semantic index information obtained from the system log knowledge graph corresponding to the upper-level sub-time span information; and
based on the similarity satisfying a preset criterion, the user interaction-based semantic index information obtained from the system log knowledge graph corresponding to the lower-level sub-time span information is treated as valid, and
based on the similarity not satisfying the preset criterion, the user interaction-based semantic index information corresponding to the lower-level sub-time span information is treated as invalid and a search into a lower layer of a system log knowledge graph is terminated.

18. The user device of claim 16, wherein the one or more instructions, when executed by the at least one processor individually or collectively, further cause the user device to:
obtain an interest knowledge graph by merging, based on application information and the sub-time span information of the lowermost layer of the preset unit time, the system log knowledge graph and the user log knowledge graph,
wherein the application information is the semantic index information corresponding to the sub-time span information of the lowermost layer of the preset unit time,
wherein the system log knowledge graph comprises the sub-time span information of the lowermost layer of the preset unit time as the root node, and the user log knowledge graph comprises a contact node having application information that is the same as the application information; and
obtain the interest from the interest knowledge graph, based on the at least one node that satisfies the preset condition.

19. The user device of claim 17, wherein the one or more instructions, when executed by the at least one processor individually or collectively, further cause the user device to generate a node representing inferred activity information as a state associated with the user within the preset unit time, based on nodes of a result obtained by merging the system log knowledge graph and the user log knowledge graph, and add the node to the interest knowledge graph.

20. The user device of claim 11, wherein the one or more instructions, when executed by the at least one processor individually or collectively, further cause the user device to obtain an entity of the at least one node as the interest from the at least one user log knowledge graph by applying, to each node, a weight based on a validity within a time span based on the time span information for determining the interest and a relevance to other nodes.
